(19) United States
(12) Patent Application Publication
(10) Pub. No.: US 2015/0347966 A1
(43) Pub. Date: Dec. 3, 2015

(54) MEETING MANAGEMENT AND PROJECT MANAGEMENT ELEMENT RECONCILIATION

(71) Applicant: Hartford Fire Insurance Company, Hartford, CT (US)

(72) Inventor: Andrew Peter Saunders, Mont Albert North (AU)

(21) Appl. No.: 14/292,907

(22) Filed: May 31, 2014

(51) Int. Cl. G06Q 10/10

(52) U.S. Cl. CPC G06Q 10/10

(57) ABSTRACT

This invention provides an improved solution for accurately importing and integrating into a Project Register relevant project register data recorded within meeting minutes, using a design and method that ensures the data imported from the minutes of a meeting doesn't produce erroneous data within the project register items, nor corrupt the documented minutes of a meeting. Consequently, the system allows for the minutes of meetings to be revised and edited, even whilst the project register items continue to evolve independent of the recorded meeting minutes and for the required reconciliation between these elements to occur seamlessly.

### TECHNICAL FIELD

This invention is a software and computer system for the recording of the minutes of meetings in a computer database and the export of the meeting outcomes to a central project register for collaborative management.

### BACKGROUND ART

Meetings which have outcomes that need to be addressed further after a meeting all face a similar problem that is, how to efficiently and effectively follow up on all the outcomes agreed upon within a meeting and ensure that they have been completed. Traditionally, the two most common used methods involve: 1) Meeting Minutes are recorded, and the minutes are distributed to meeting participants and relevant parties to enable follow-up. 2) Subsequent meetings are used to evaluate progress of previously agreed upon meeting outcomes. Traditional methods for meeting follow-up have significant issues. One meeting outcome that is very pertinent to further exploring this is actions/tasks, and will be used as a representative meeting outcome within this section.

If a person in an organisation was to attend ten different meetings in a week, they would have to rely on their memory, or work through ten different minutes documents to find the actions for which they are responsible. Alternatively, a manager who attends 20 different meetings a week, and asks people to do say 100 different tasks would have to analyse 20 different meeting minutes and hold more follow-up meetings to verify progress. This has a time opportunity cost for all involved.

The traditional methods of keeping track of all these actions are notorious for being ineffective and inefficient. It is very easy for individuals and managers to miss the follow-up of important meeting outcomes. To counter this, individuals often begin to make lists of the actions they have been assigned. Chairs of meetings or managers also do the same, detailing in lists the actions they have assigned. Some meeting minutes even become more like giant lists of actions. Formatted in spread sheets, this style of minute taking is very common in the construction industry.

The challenge with individual lists is that an individual's action/task list isn't reconciled to a managers list. If an individual notes delays, progress or completion on their list, this isn't automatically reconciled to say their team members' or manager's list. Very quickly the task of maintaining up to date lists becomes a time consuming task.

Software, such as client-server project registers, can be used to address this problem. Project registers provide a central archive on a server that creates a shared space where items such as actions, issues, risks, change orders, decisions, documents, etc. can be recorded. Projects and programs have been using project registers for years. They significantly increase the ability of a management team to deliver a project in the shortest duration, at the least cost and with the highest quality.

To take advantage of a project register, after a meeting, the meeting outcomes could be both recorded in the minutes, and also in a project register. The project register would then provide a facility for staff to be able to collaboratively work on the completion of the meeting's outcomes.

To have a subsequent progress meeting on the outstanding outcomes, one could go into the project register and print off the individual status of the required items. These would then be taken to the meeting for discussion. Any updates to these outcomes would be noted in the progress meeting's minutes, and the respective items within the project register would also be updated.

While the above method is practically feasible, it is rarely used. The reason for this is that it requires the double handling of data. The more frequently meetings are held, and the larger the number of meeting outcomes being managed, the more laborious this process will become. Eventually the time-opportunity cost outweighs the advantage of using this method.

Due to inefficiency associated with manually reconciling project registers with meeting minutes, the next evolutionary step in system design is to automate the minute taking. and/or the entire meeting process and seamlessly integrate them. In such a system, it would be possible to create or update project items within a project register, directly from a meeting interface. This feature would be in addition to being able to update the project register item directly from its own interface.

Prior art to date have focused heavily on the opportunities that are created by networked computer systems to replace the older video conferencing systems. This type of system is known as an Electronic Meeting System (EMS), Group Support Systems (GSS) and Group Decision Support System (GDSS). See Wikipedia “Electronic Meeting System” and also the section in the list of Citations.

A structured meeting interface using a client-server design allows for a lot of additional meeting information to be captured in comparison to a free form text minutes document. The following paragraphs outline the large majority of the possibilities that have been focused on with Electronic Meeting Management Systems:

Using a client-server network synchronous collaboration on all aspects of the meeting and its documentation, including agenda and minutes production can be done. Participants can simultaneously see the meeting minutes being produced as the meeting progresses. (Curtis et al. U.S. Pat. No. 8,266,534 B2) and a lot more data can be captured.

Integration of the audio record of the meeting with the actual documented minutes. The individual part of the meeting can be time stamped. For example, discussion on agenda item 1 might begin 2 mins and 20 seconds into the meeting, and end 7 minutes and 40 seconds into the meeting. The time stamping could be achieved through a manual interface requiring user input, or it could be achieved when a new agenda item is selected. (Braunstein et al. US 2005/0131714 A1)

Content discussion around the meeting can occur in different forms. This includes formal threaded discussion, or live text chat around the meeting which becomes part of the meeting record.

Audio and video contributions to the meeting have also become part of the meeting record. Participants can pre-record contributions to the meeting, live video conference feeds are recorded as well.

Centralised storage of electronic documents associated with the meeting, with all meeting participants granted access to either read or contribute documents.

Documentation of the meeting can be assisted through the use of the audio file to produce a complete transcript of the meeting. This could be done manually or using an automated process. Such a transcription could also be used as the basis to produce the actual minutes of the meeting. (Poirier. U.S. Pat. No. 7,047,192, Din. U.S. Pat. No. 6,754,631, Doyle et al. WO2006089355A1 and Adams et al. U.S. Pat. No. 6,100,882)

Meeting content publication: Using all the additional information gathered on the meeting, this can be used to build a complete record of the meeting. The output of such a record would utilise various formats, XPS, PDF, DOC, DOCX, HTML. A more intricate output might build a record with a web-based portal that had a common page for the meeting with sections for all of the information collected. One example of prior art in this area is MinuteTraq, released by IQM2.

Meeting content can also be exported to other software packages for content presentation or further analysis. This might include scheduling software, presentation software, calendar software, etc.

There are many meeting minutes systems that produce minutes and simple task lists from the minutes. There are only a few systems however known to the inventor that have produced solutions that seriously tried to address the reconciliation issues that occur between a meeting minutes and a project register.

One existing software package known to the inventor is the LOTUS NOTES (trademark of the IBM Corporation) application TrackMeet by Kolaco Inc. In this software, when the meeting minutes are published, the action items in the minutes are exported to the project register. The software can automatically construct an agenda for the next meeting by importing from the project register the action items still outstanding from the last meeting.

Any updates to the imported Action Items are recorded during the meeting. When the new meeting minutes are finalised and published, the imported action items are exported back to the project register as a new version of the action that includes the meeting changes. The more meetings you hold regarding a particular action, the more versions of that action are created in the project register. Each version created is directly linked to its relevant meeting. If there are changes to the meeting minutes, this is updated in the project register version. The result is that the project register now has multiple action items recorded for the one package of work (one action), and the history of an action is split across all of the separate action items.

This system is very inflexible as it requires a meeting to be held and minutes published to maintain the action items in the project register. As meetings also create multiple action items for a single package of work in the register, this software's method also reduces the register's overall usability.

Another software package known to the inventor is the Layer2 Gmbh software package “Meeting Manager for SharePoint” which uses the file versioning that is built into SHAREPOINT (trade mark of Microsoft Corporation) to record changes to Action items. As the versioning is controlled by SHAREPOINT any change at all to the Action Item results in a new version being created. As will be demonstrated later using versioning in this way will almost always result in a loss of synchronisation between the Meeting Register and the Project Register.

The pertinent point is that none of the existing solutions focus on the significant technical difficulties of actually integrating meeting minutes with a project register, whereby the meeting can both create and update items within a project register without producing erroneous data.

### Technical Problem

The accuracy of a project register and its ability to follow up on items is its value. As such, if a project register is going to integrate with a meeting minutes interface, it has to be done in such a way that it doesn't inappropriately change the data within the project register's items and consequently produce erroneous data. It is the data within a project register that is used to generate management reports, and guide decision making. Starting from the project register, the inventor worked backwards to try and establish how to capture data from meetings accurately, and integrate that information. There are two key enabling steps to ensure the data remains accurate within project register items, when they are receiving an update from a meeting interface. Firstly, the system needs to accurately capture the required data for the project register item from a meeting, or a project register item's interface. Secondly, the captured data needs to be appropriately integrated with the project register item.

Data Capture from a Meeting: Designing the system to capture the relevant data from meeting minutes requires creativity. Firstly, meeting minutes are traditionally recorded in a free form text document. The project register however is a database. For the project register to be updated, a design/method is required to identify within meeting minutes the relevant database records. Although challenging, there is prior art in this area that outlines various methods on how to achieve this.

Data Integration from Meetings: The second step of how to then integrate the captured data and use it in a way that doesn't compromise the integrity of a project register's data, is a complicated and neglected area. There is currently no known prior art or known implemented method that outlines a successful method to address the problems that are raised by integration.

Existing prior art is rather heavily concentrated on the possibilities for synchronous or asynchronous collaboration in electronic meetings. The focus is on the meeting and its capabilities. In contrast, this invention has a management focus. Starting from the project register, the inventor worked backwards to the meeting to try and identify data reconciliation problems, and develop methods to integrate the project register with meeting minutes without compromising the accuracy of the project register.

Before describing the invention, it is necessary to describe in detail the elements being integrated and their requirements. These are, meeting items and the various types of project register items. It is then possible to describe the challenges and problems with integrating these elements. In order, the items discussed will be: 1) Project Register Items. 2) Meeting Items. 3) Understanding Integration.

Project Register Items Overview.

There are four key concepts that need to be addressed to understand relevant details about project register items, and any project register must have them to achieve successful integration with meetings items. Firstly, that all project items must use the same layout structure and support functions. Secondly, project items must store their key relevant data. Thirdly, that project items can evolve. Four, there should be a clear difference between a project register items details and its progress updates, and it is important to know what an update refers to. Finally, it's important to understand the consequences to progress updates if the items details were to change. In order of discussion, these project register item concepts are: 1) Layout Structure and Methodologies. 2) Information Stored. 3) Project Register Items Evolution. 4) What are Updates? 5) Consequences of Changing a Project Items Details.

Concept 1—Layout Structure and Methodologies: Examples of project items include action items, issues, risk items, change orders items, decision items, electronic documents, etc. Although project register item types capture different information, their overall structure and how they represent their data, and what rules they use to update their data must be similar.

Concept 2—Information Stored: Project items should store pertinent information relevant to their project item. If you open up an action item for example, there is certain information you will want to know. Firstly, as a minimum you will want a description of the action to be completed, who has been asked to complete the work and by when. Then you might also want to know who requested the action to be done, how critical it is, and see any attached documentation supporting the work to be completed. Similarly, a decision item will need to store information about the decision, and who made it and when.

Concept 3—Project Items Evolve: The next key feature about project items is that they need to be able to evolve over time. An action for example might begin with a due date of next month with the responsible person being Mr X, and then be changed at a later point to have a due date of two months with the responsible person being Mr Y. So an action item will need to clearly display the most recent action details, and it is also valuable to see the history of an action item's details and how they have changed over time. This must the same for all project items.

Concept 4—Before discussing ways of managing and sequencing project item information, it is important to understand the difference between a project item's details, and a project item's progress updates, and what an update refers to. Consider an action item; its details define the package of work to be done, and progress updates in some shape or form comment on the action item's progress to completion.

When a meeting minute or a project register updates a project item, the word “update” refers to two possible options. The update could be changing an action item's details (Example 1), or adding just a progress update (Example 2), or the update could be doing both (Example 3).

Example 1: This is an example of an update that changes the action's details. The Action Item Details might be: “Pour some concrete, due date is the end of next week, responsible Mr. X” and the Progress Update 1 might be: Mr. X comments, “I really can't get this done by the end of the week, please reassign if possible”. Reassigning the action to someone else will result in a change in the Action Item Details. Action Item Details Update: “Pour some concrete, due date is the end of next week, new responsible Mr. Y”.

Example 2: This is an example of an update that is just a progress update. The Action Item Details might be: “Pour some concrete, due date is the end of next week, responsible Mr. X” and the Progress Update 1 might be: Mr. X writes, “I need more help to get this done by next week” and the Progress Update 2 could be: Mr. X writes, “Mr Y says that he can help me”

Example 3: This is an example of an update that changes both the action's details and adds a progress comment: The Action Item Details might be: “Pour some concrete, due date is the end of next week, responsible Mr. X” and the Progress Comment might be: Mr. X comments, “I need more help to get this done by next week”. Reassigning the action to someone else results in a change in the action item details. Action Item Details Update: “Pour some concrete, due date is the end of next week, responsible Mr. Y”. This may be accompanied by a comment Update: Mr. X comments, “Mr Y says that he can do it on time”

Concept 5: Changing a Project Item's Details: Looking at the above example—It is also important to note that if an action item's details were to change, then any progress updates that had been made in reference to the old details, may no longer make any sense. This is an important concept, and will be revisited later in the Solution Section.

Meetings Items Overview.

There are three key concepts that need to be addressed to understand the relevant details about meetings to allow integration with a project register to be successful. Firstly, meetings go through phases. Secondly, meeting minutes can be produced at different times relative to the meeting. Thirdly, how to capture meeting minutes in a way that allows for their integration with a project register database. Finally the challenges involved in saving a structured document to a database will be outlined.

Concept One—Meeting Phases: A formal meeting will go through stages over a period of time, and the meeting's minutes will be progressively produced. There is: 1) Inception of a meeting by the originator. 2) Meeting invitations are sent to participants with a proposed agenda and 2) Agenda Feedback is obtained (if required) and finalised in preparation for the meeting. 3) The Meeting is Held. 4) The Meeting minutes are produced. 5) Meeting minutes feedback is obtained (if required) and finally. 6) The Minutes are published as the official record of the meeting (finalised). An informal meeting might skip most of these stages. An impromptu meeting could be called, the minutes taken live, and sent out at the end of the meeting as final.

Concept Two—Meeting Minutes Production Time: As just mentioned, meeting minutes can be produced live during the meeting. They can also be produced retrospectively for past meetings. Alternatively, they can be produced in draft for a future meeting (a project management technique) with final revisions occurring after the meeting. The importance of this will become clearer when analysing data integration from meetings.

Concept Three—Capturing Structured Meeting Minutes: The third element required for an integrated meeting—project register system is to understand how to arrange a meeting interface in such a way that it can produce meeting minutes and also accurately capture the data required to be exported into a project register database.

Software users would likely prefer to use the most traditional method of capturing minutes, which is using a free form word processing document that is structured entirely at the discretion of its author. As a project register is a structured database, the system would need to identify within the custom text document the field values required. Unfortunately, this is nearly impossible as the export field identification script (e.g. Allen et al. U.S. Pat. No. 7,146,381) that scans the document can never be 100% sensitive and specific. The system would therefore identify for export things that were not meeting outcomes (false positives), and miss others (false negatives) that should have been captured. This would then require a meeting participant to check the exportation list, and remove incorrectly identified meeting outcomes, and add those that were missed.

Any effective system design consequently has to diverge from the conventional method of recording minutes in a purely free form text document, to using a software interface that is capable of capturing the minutes in a more structured manner. This more structured method then allows for the accurate identification of the meeting project register outcomes within the minutes, that are ultimately exported to a project register for follow-up. The following paragraphs outline the known methods to capture the meeting outcomes in a structured manner: Method 1: Free Form Text and Structured Lists, Method 2: Hierarchical Meeting Minutes, Method 3: Free form text with embedded objects, Method 4: Free form text with hierarchical embedded objects.

Method One: Free Form Text and Structured Lists. One of the simplest methods is to have a meeting window that has a section for free form text, and then has separate sections to record meeting outcomes. To produce the minutes, the system appends to the free form text the list of outcomes. It then exports to the project register the meeting outcomes for tracking. An example of such a commercial package is Kolaco Inc's “TRACK MEET”.

Method Two, Hierarchical Meeting Minutes: Braustein et al. (US 2005/0131714 A1) describes making a meeting minutes document that is made up of individual meeting outcomes that can be organised into a hierarchical tree, and organised sequentially. So for example, you might have on the hierarchical tree an agenda item (level 1), with a “child” element that is a meeting outcome—a decision (level 2), which in turn has 3 more “child” meeting outcomes—2 action items (level 3), 1 risk item (level 3). With each part of the meeting recorded in its elemental blocks, the system can produce a meeting minutes document, and export the relevant meeting project register outcomes to the project register.

Method Three: Free Form Text within Embedded Objects. It is possible to use a free form word processing document that is specifically designed to allow for embedding meeting outcome objects. For example, a user who has written up meeting minutes in a free form word processor could drag into their document an action outcome object that has several mandatory fields that must be completed. The object would be nestled within the document like a table or a picture, but it would be specifically designed to link to the project register database. The meeting minutes would be produced as per the free form document. (Moran et al. U.S. Pat. No. 6,018,346 A).

Method Four, Free Form Text with Hierarchical Embedded Objects: It would also be possible to have hierarchical meeting outcome objects embedded within a free-form document, enabling exportation of meeting outcomes with their relationship to each other captured. The meeting minutes would be produced as per the free form document.

Irrespective of the method selected, these structured systems can accurately capture the details of new meeting outcomes, or updates to existing project register items. Before looking at the relationship between meeting minutes and the meeting outcomes captured, and their integration with a project register, it's important to understand more about project register items.

Concept 4—Structured Meeting Minutes and Saving: One of the final challenges of capturing meeting minutes in a structured form is saving. In a free form document you can save the content whenever you want. If you use a structured method to capture project register data, the objects within the meeting have certain fields that must be completed before a document could export its relevant content. The challenge of system design therefore becomes how to let users save their document anytime they want, without introducing errors into the project register from incomplete objects.

Understanding Integration.

A meeting management—project register system needs to be able to document a meeting accurately and be able to interface with a project register and have the capacity to: 1) Create a new project item within a project register. 2) Update/close an existing item within the project register. 3) Handle the revision of meeting minutes and any consequential changes to the project register.

These tasks need to be achieved whilst ensuring that the data in the project register is accurate and reflects the natural workflow of project items. To achieve this there are some core ideas in the relationship between meeting minutes and project items that need to be addressed. These elements will be discussed in the following order: 1) The relationship between Meetings and Project Items. 2) When to Export Meeting Project Register Outcomes. 3) Project Item—Meeting Item Integration Problems.

Relationship between Meetings and Project Items: The first element to understand about meeting and project item integration is the independence of meetings from project items in the project register. If the meeting minutes include a new meeting project item outcome, it is an object of that meeting. At the moment of exportation, the system will create a new corresponding project item in the project register. The project item is then a new autonomous object in the project register. At this exact moment, the meeting action outcome in the minutes represents what was discussed about the action at the meeting, and the action item in the project register is a copy. However, they are two separate objects.

Some systems create a direct link between the meeting and the project items. Therefore if you subsequently change meeting minutes you automatically change the project item. This may seem ideal but it has the unacceptable downside in that if you change the project item directly in the project register, you inadvertently change the minutes of the meeting. In effect the meeting minutes are no longer an accurate record of the meeting.

When to Export Meeting Project Register Outcomes: The second element to understand about meeting and project item integration is when a system should export its meeting project items outcomes to the project register. There are some advantages to exporting after the meeting minutes are published in final form. At this point in time, the quality of the data in the meeting minutes is at its highest, and it is unlikely to change. In this way, people following up on meeting outcomes in the project register would have a high level of confidence that the meeting outcome that they are assigned to follow up on won't change.

The reason not to follow this option is because often it can take weeks for minutes of a meeting to be finalised, and in reality people will start working on actions as soon as they have been publicly assigned (e.g. in a meeting, or notified). Any system of value needs to support natural work flow, so project items discussed in a meeting should be exported to the project register before the finalisation of the meeting minutes.

Project Item—Meeting Item, Integration Problems: Using any one of the four structured meeting methods outlined previously to capture a meeting's project register item outcomes, the captured data can be directed to its relevant project register item. The project register item then needs to accept the update. The details and updates of the item need to be arranged and presented in such a way that the most recent project item details and its past history is accurately displayed, is useful to the user and represents the natural workflow of a project register item. As we shall see shortly, this is quite difficult. This is because the design of such a system needs to overcome four specific design challenges produced by meetings. 1) Minutes are produced after a meeting. 2) Future Meetings. 3) Multiple updates from a meeting. 4) Corrections to minutes.

Problem 1. Meeting Minutes are Produced After a Meeting

Meeting minutes are rarely recorded live. They are usually produced after the meeting, and the quality of the meeting minutes improves over time as it is reviewed before being ultimately marked final. This has consequences for ordering updates within project register items.

Many commercial project register packages, sequence updates to project register items in the order that they receive them. Updates from meetings minutes, and updates from the project item's interface would therefore be sequenced in the order that they are created within the item. This causes problems when interfacing with meeting minutes, because as noted, meeting minutes are produced some time after the meeting, and an update at this moment doesn't reflect the natural sequence of events for a project item.

In trying to understand this problem, we can consider a progress meeting. In this meeting, participants come together and discuss new project register items and update old ones. Project register items will be publicly discussed and next steps agreed upon during the meeting. Consequently, after the meeting, participants are likely to begin following up on the project register items they are associated with.

In contrast however, meeting minutes are rarely produced immediately at the end of a meeting. Usually a meeting attendee will take notes on the meeting events and then produce the minutes of the meeting at a later point. Relating this back to system design, the minute taker will export the meeting's project register item updates to the project register, once the minutes have been produced.

Because of this delay, meeting attendees might follow up on a project item before the meetings minute's update is exported to the project register. This introduces the opportunity for errors to occur. In this time, a project item might receive a new update directly from changes made to the project register item or alternatively from a subsequent progress meeting. If this occurs, when the original minutes are produced and the project register item outcome updates are exported from the meeting, the project register item's updates will be out of order and erroneous data will be produced. The longer the time between the actual meeting, and the production of its minutes, the greater the chance an error will occur.

FIG. 1—Past Meetings outlines this problem in more detail. A new meeting 102 is held and recorded in the system as ‘Meeting Object 1 104’. An existing Action Item, ‘Action X Object 106’ in the Action Register (a project register module), is imported into the agenda of the meeting and is recorded as ‘Meeting Object 1—Meeting Outcome Object 1 108’. As a result of discussions during the meeting, it is agreed that ‘Action X Object 106’ will be assigned the new date of the 30-OCT-2013. This change is recorded in ‘Meeting Object 1—Meeting Outcome Object 1 108’ and becomes part of the draft minutes of the meeting. No change will be made to the ‘Action X Object 106’ until the contents of the minutes are exported. Mr Jones decides the following day, before the meeting minutes are ready, and its contained information is exported to the Action Register that he needs to change the due date of the Action Item to the 30-JUN-2013. He does this using the Action Item Window 110. This creates ‘Action X Object—Update Object 1 112’ within ‘Action X Object 106’ with the due date of 30-JUN-2013. This process updates the ‘Action X Object—Properties 114’. The ‘Action X Object’ new due date is 30-JUN-2013. Subsequently the meeting minutes are exported 118 at 5 pm, 4-APR-2013 and a new update object is added to the ‘Action X Object’ 106, the update ‘Action X Object—Update Object 2 116’ with the due date of 30-OCT-2013. Again the process updates the ‘Action X Object—Properties 114’. The new Due Date is 30-OCT-2013. Anyone looking up the Action Register for this item's due date will now find the action item's due date is not the most recent allocated and is therefore wrong.

Problem 2. Future Meetings

“Meetings in the future” pose a similar chronology problem for ordering a project item's history. A common management technique is to draft a meeting agenda, complete with new action items or current action items required to be started or done before a meeting. In effect the meeting chair (usually a manager) is inserting into people's task list, items the chair wants done without any prior discussion. Without determining whether this is good management practice or not, it is a common enough occurrence that it needs to be supported by meeting management software. At the meeting set for a time and date in the future, the meeting chair will then check on the progress of the actions. Principally, the meeting participants will be people with assigned actions.

This technique poses chronology challenges for a project item's history, as you are managing updates in the present for a meeting that will occur in the future. It is again imperative that the system models a project's natural work flow.

Problem 3. Multiple Update from a Meeting

During a meeting, a single project item maybe discussed multiple times, with other meeting content discussed in between. Within the meeting minutes, to capture the multiple discussions about a single item, one could record all the different discussions in one meeting outcome, but this wouldn't be an accurate account of the sequence of events that occurred during a meeting.

Therefore, any meeting management system needs to be able to capture multiple updates for the same action at different points within a meeting. Consequently, the meeting will produce multiple meeting outcomes to be exported to the project register for the same project item.

Whilst also addressing the issues raised by problem 1 and problem 2, the system needs to be able to receive the multiple updates from the same meeting for a project item. Upon receiving this exported data, the project item needs to be able to do two things. Firstly, order the updates in the correct chronology as per the order in the meeting. Secondly, the system needs to correctly handle any consequential project item detail change, from information contained in the multiple updates.

Problem 4. Minute Revision

After the meeting minutes are produced and items have been exported to the project register, if the meeting minutes are then altered, this introduces a problem of reconciliation. Although the project item is distinct from its related meeting outcome, they are still related in content. Therefore, if a meeting minute changes, this change needs to be also reflected in the corresponding project register item.

For example, if an action item was incorrectly noted in the meeting minutes as being due in 2 months, and this is exported to the project register, the action item will be marked for completion then. If the minutes are revised after two weeks and the correct due date of one month is now recorded in the minutes, this change needs to be exported to the project register to potentially update the relevant project register item.

If you change a project item's details as above, subsequent progress updates that were created after the original update in the project item, these may no longer make sense. Therefore how items in a project register are updated as a consequence of revisions to meeting minutes is crucial.

The difficulty with revising minutes and exporting the change is that one is exporting a change to an update that was created in the past.

### Solution to the Technical Problems

How to accurately transfer data from meeting minutes to project register items, mitigating the integration challenges, is at the core of this invention. It was necessary to:

Design project register item interfaces, support functions, and invent; a layout for their content that allows them to receive updates from both the project register itself and also from meeting minutes, integrate meeting minute revisions, and represent the current data as well as each item's chronological history accurately.

Design a meeting item interface and support functions, that could capture key meeting information and minutes, whilst identifying the relevant project register outcomes, and invent; a method that allowed the meeting minute's window to approximate the behaviours of a free form text document, allow saving, and also guarantee the accuracy of the data being passed to the project register item's database tables.

Invent a process to ensure that data being passed from a meeting item to the project register item does not update the project register item in an inappropriate way so as to produce erroneous data.

### Advantageous Effects of the Invention

This invention provides an improved solution for managing a meeting and its outcomes in the Project Register. It allows a Project Register to be maintained with accurate data on projects and also integrate Project Register data from electronic meeting systems without producing inaccuracies in the Project Register or the Meeting Minutes Register.

### DESCRIPTION OF DRAWINGS

FIG. 1 Past Meetings.

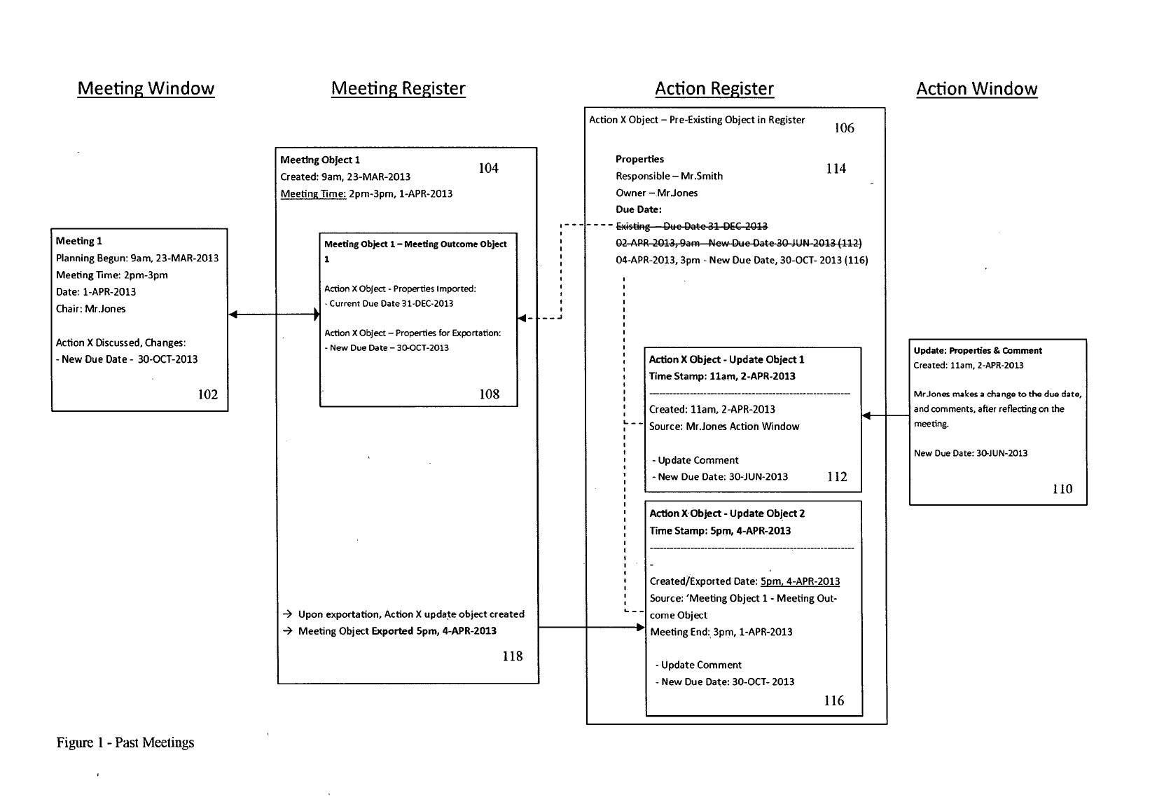

FIG. 2 Meeting Minutes window with Action Item

FIG. 3 Versioning vs Update with Comment

FIG. 4 Past Meetings using Rule Number 1

FIG. 5 Future Meetings using Rule Number 2

FIG. 6 Multiple Updates Rule Number 4

FIG. 7 Overwriting Action Item keeping original date and time

FIG. 8 Append to Action Item

FIG. 9 New Action Items updates become the parent of Action Item

FIG. 10 Sequential Updates

FIG. 11 Flow chart with updating options

FIG. 12 System Design

### DESCRIPTION OF THE EMBODIMENTS

Various aspects are now described with reference to the drawings. In the following description, for purposes of explanation, numerous specific details are set forth in order to provide a thorough understanding of one or more aspects. It may be evident. however, that the various aspects may be practiced without these specific details. In other instances, well-known structures and devices are shown in block diagram form in order to facilitate describing these aspects. As used in this invention, the terms “component”, “module”, “system”, “register”, “Audit trail” and the like are intended to refer to a computer-related entity, either hardware, a combination of hardware and software, software, or software in execution. For example, a component may be, but is not limited to being, a process running on a processor, a processor. an object, an executable, a thread of execution, a program, and/or a computer. By way of illustration, both an application running on a server and the server can be a component. One or more components may reside Within a process and/or thread of execution and a component may be localized on one computer and/or distributed between two or more computers. Various aspects will be presented in terms of systems that may include a number of components, modules, and the like. It is to be understood and appreciated that the various systems may include additional components, modules, etc. and/or may not include all of the components. modules. etc, discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones. personal digital assistants (PDAs). and other electronic devices both Wired and wireless.

The invention consists of a software meeting-project management system configured to run in a client-server arrangement, using personal computers, mobile computing and server hardware. The innovation of the system is its ability to accurately capture data from documented meeting minutes, and then integrate that data with a project register whilst maintaining the integrity and accuracy of both meeting minute's records and the project registers entries. As outlined in the background, this required a detailed understanding of the complexities produced by meetings, and their subsequent integration with a project register.

The server part of the software is composed of two main software components. The first component is the server software running on hardware that is capable of managing the communication between client software and the system's database. The second component is the systems database running on a database server. The database server can be running on the same server as the server, or it may use its own dedicated hardware.

The client software is a client application running on a personal or laptop computer. The software can also be used on a single computer which runs all of the three components, the server, the database and the client application.

As the system is configured to use a client-software arrangement, the system is able to support the development of further client software, in particular for mobile devices, smart tablets and a web-based thin client. The system communicates between the server and the client server using secure encrypted communication.

The integration between the client software and the server software is configured to enable the features that are outlined below.

The design of the system is such that it is comprised of modules. The modules are a way of grouping and managing related content. For example, for an action item module, would be made up all the input screens and methods/functions, and related database tables required to record an action item, and manage its content in unison with the other modules. There are three different types of modules, the management modules, the configuration modules, and the information modules.

Management Modules: The management modules are made up of the meeting module and the project register modules. The system is designed to allow for expansion and the addition of additional project register modules, and they would use the same architecture and methodology as the others.

The meeting module: The meeting module is comprised of all the meeting window interfaces, management methods/procedures, and database tables required to create/edit, store and retrieve, and display records of meeting.

Project Register Modules: The project register is made up of individual modules for actions, issues, risks, decisions, deliverables and change requests. Each management module has window interfaces, management methods/procedures, and database tables required to create/edit, store and retrieve and display records of the project item.

The system also has two configuration modules the Folders module and the Contacts module

Folders Modules: The folders modules allows for the creation of a hierarchical folder structure. The folder structure has a method to control use and access to folders. All items within management modules are allocated to a folder. Although items are still being stored in their respective module's tables, by using the configuration modules, the system can control access to items, and from the user's perspective, each item appears to be located within its respective folder.

Contacts Modules: The contacts module manages the creation and editing of contact details, which can then be used throughout the system. The module is comprised of all the window interfaces, management methods/procedures, and database tables required to create/edit, store and retrieve for display, contact records.

The system also has information modules consisting of the dashboard module, and the search module.

Dashboard Module: The system has a dashboard that is capable of being customised to display key data relevant to a user, drawn from each of the separate modules.

Search Module: The system has a module that is capable of searching each of the other modules looking for relevant data.

Reporting: Each module has functionality that produces a range of reports on each of its items.

Integration Overview: As mentioned, the core of the invention is how the system accurately integrates information contained within Meeting Minutes with information in a project register. To do that there are three core elements involved; meeting items, project register items, and the system's Integration methodologies. Outlining how these elements work in details explains how the system innovatively and accurately links meeting minutes with a project register. Each element relies on; its software interface design, methods and functions, its corresponding database structures, the system's client-server communication structure, and the hardware platform supporting the client and server software platforms.

The integration elements will be addressed in following order: 1) Meeting Items. 2) Project Register Items. 3) Integration Methodology

Integration Elements 1 Meeting Items

Meeting Item Design Overview: To understand how a meeting is managed within the system, the core features of a meeting item will be described: 1) How to create a meeting item within the system. 2) The general features of a meeting item. 3) How a meeting item window lays out its meeting minutes. 4) How the meeting item window specifically captures data for the project register from both new project items and existing project items. 5) How and when the system will export the data contained within a meeting's project register item outcomes, to the project register. This exportation occurs within the context of a meeting's life cycle and this will be explored first. Then how the system performs the saving of a meeting item, back to the server, and how that then allows for user collaboration will be described. Finally, the meeting item reporting capabilities are described.

Meeting Item Design. The topics will be covered in the following order: 1) Creating and Editing Meetings. 2) The general Features of a Meeting Item Window. 3) Meeting Minutes Layout Structure. 4) Project Register Item Outcomes. 5) Meeting Phases and Exportation. 6) Exportation Data Validation. 7) Saving Meeting Items. 8) User Collaboration. 9) Meeting Item Reporting

Meeting Item Design Part 1: Creating/Editing Meeting Items

Within the system, the creation and editing of meeting items is managed by the meeting module. The module however can be instructed to create a meeting item from various sources, and likewise can be passed data to populate the new meeting item being created. The source of the instructions is the meeting module or the project register.

Meeting Module—New Meeting Item: From anywhere within the system, the programs interface allows the user to create a new meeting. The instruction will be passed to the meeting module to be executed.

Meeting Module—Cloning a Meeting Item: To clone a meeting item, the user must go into the meeting module, select the item to be cloned, and then instruct the system as to which content from the old meeting the user would like to be cloned. Then the system will create a new meeting populated with the content selected for duplication.

Meeting Module—Editing a Meeting Item: To edit a meeting item, the user must go into the meeting module, open the relevant meeting item, and then make their changes.

Source Project Register—Update Meeting: Existing project items can be selected from multiple project modules, and they can be used to create an update meeting. This will be outlined in more detail later.

Meeting Item Design Part 2: General Features.

The meeting item window interface is able to capture a range of meeting information. This includes information about the meeting, its logistical details, attendees, and the minutes of a meeting and electronic copies of the relevant meeting files/documents.

The meeting window runs on the users computing device, whether a personal computer or mobile device. The window can collect or edit information about a meeting. When the user instigates the saving method on the meeting item window, the data collected about the meeting is communicated by the client program, from the users computing device, across the relevant communication network to the system's server. The server running on computing hardware then processes the data and sends it to the database server. The database server running on the same or different computing hardware uses the data it has received to create a record in the meeting tables of the systems database.

Once the meeting item record has been recorded in the system's database, via the server and the client program, the record is now visible to other users of the system that have access to the folder to which the project register item was allocated. Multiple users can now access the same server record, and this allows for synchronous or asynchronous collaboration.

The meeting item window also has five key functions supporting it: 1) Audit Trail. 2) Attachments. 3) Validation. 4) Snap Shots on Phase Change. 5) Related Meetings.

Meeting Item Support Function 1—Audit Trail: There is an audit support function which keeps a record in a separate database table of every single change made to the meeting item record, when the change occurred, and by which user. This can be only be viewed by a system administrator, who is then able to then audit each individual change made to a meeting item.

Meeting Item Support Function 2—Attachments: There is a attachments support function which itemises all the attachments that are associated with any part of the meeting item. They are categorised as per their source and can be opened for viewing.

Meeting Item Support Function 3—Validation: As mentioned, the meeting item is stored in a database. Therefore, unlike a free form document which does not require any particular data to be entered, the database requires certain fields to the accurately completed at different moments of the meetings life cycle. To support a user to know which information they might not have completed accurately, the meeting item window has a validation function. It specifically flags the incomplete information. The function evaluates missing information and classifies it into three categories. These are: ‘Error’, ‘Warning’ and ‘Information’. The meeting cannot be saved while it has any errors. As a system rule, only errors need to be resolved first before a meeting can be saved.

Meeting Item Support Function 4—Snap Shots: When a meeting changes phases, a concept that will be discussed shortly, the system takes a snap shot of the meeting item record. It is a copy of the meeting at the moment of capture that can be access as an interactive window, or statically as a PDF report. This allows a user to see a record of the meeting at each key moment of its life cycle. A practical example of this feature is as follows: Suppose a meeting is finalized. A snap shot is taken of the meeting. Then a user reopens the meeting for revisions, and edits the minutes. The user then finalises the meeting again. If another user wants to know what's changed, they can compare the two finalised minutes documents stored in the snap shot function.

Meeting Item Support Function 5—Related Meetings: Meetings can be related to each other. For example, a team might have a regular Monday morning that goes through outstanding action items. . . . Meetings can be linked together in series at the discernment of a user. This function provides a space for a user to see what meetings are related to the current meeting, and open them.

Meeting Item Design Part 3: Meeting Minute Layout Structure.

Capturing the minutes of the meeting can be configured within the system to use either of the following methods outlined in the background section, which are: Method 2: Hierarchical Meetings; or Method 4: Free form text with hierarchical embedded objects.

Meeting Item Design Part 4: Project Register Item Outcomes.

Using method 2 or method 4, the meeting minute's window is able to dedicate specific objects to accurately capture pertinent details regarding the project item's details. For each project item type, there are two dedicated objects with different entry fields to capture meeting project register item outcomes. The first object type creates new project items within its respective module, and other meeting object type updates an existing project register item within the project register.

New project Items—meeting objects: The object within a meeting to create a new project item has fields available to capture data from the user regarding the new item. There are core fields that must be completed before exportation, and additional fields which are optional.

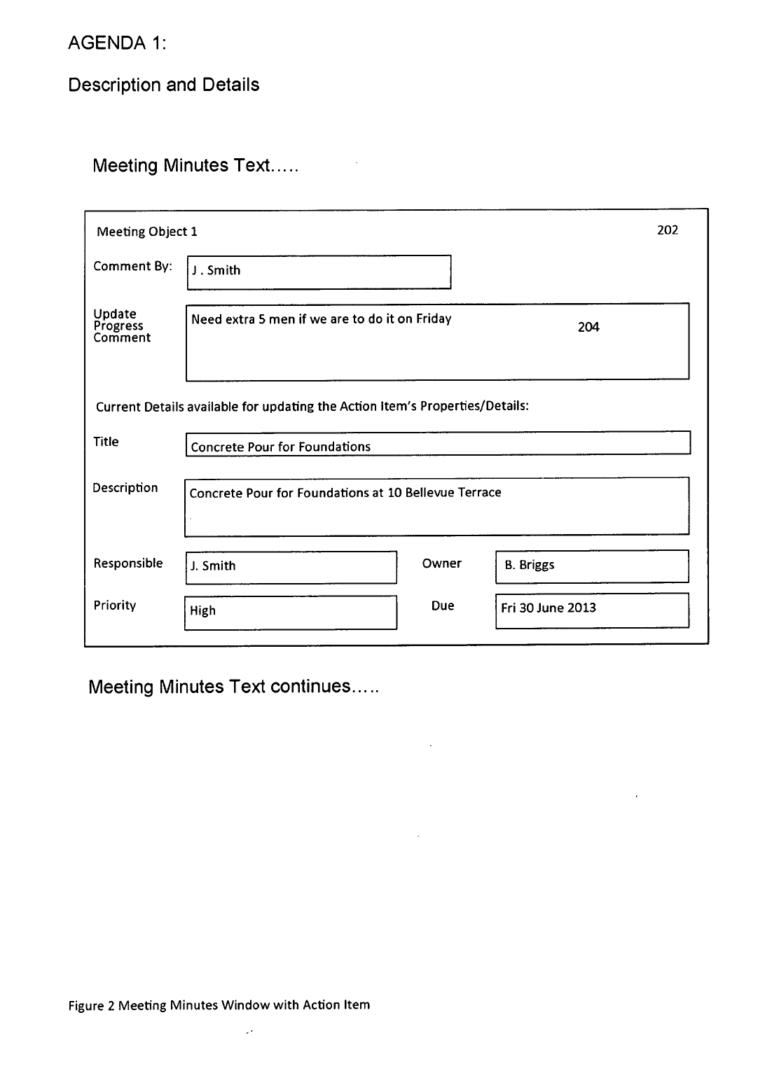

To create the update object of a project item in the meeting minute's window, the system needs to know which item within the project register the user wants to update. There are methods to select the required project item within the system. Once the required item is selected, the details of the project item are imported into the meeting window. Refering to FIG. 2, an imported project item in a meeting is shown as ‘Meeting Object 1’ 202. These details can be updated, and a progress update of the project item recorded 204. There are core fields that must be completed before exportation, and additional fields which are optional. This object becomes a record of the meeting, and also is now able to export its update back to the project register.

Meeting Item Design Part 5: Meeting Phases and Exportation.

As noted in the background, a meeting goes through several stages, from inception through to the minutes of meeting being published. In terms of the systems design, we have grouped these stages, and called them meeting phases. Referring back to the background section for all the meeting stages, there are three meeting phases:

Phase 1, Draft—Draft incorporates every moment of a meeting's life cycle right up to when the minutes of the meeting are produced, and marked as complete for review.

Phase 2, Minutes in Review—This phases incorporates all the discussion and revision of meeting minutes right up until the moment when the meeting minutes are marked as competed.

Phase 3, Minutes Produced—This phase is when the minutes are complete, and no longer open to further revision.

Similarly discussed in the background section, when a meeting item exports its data to the project register, this needs to occur at a moment that supports the natural workflow of items. As outlined, meeting participants potentially begin following up on meeting items from the moment a meeting ends. This would be the ideal moment to have the minutes signed off and finalised, and export the meeting's project item outcomes to the project register. This rarely occurs though, and meeting minutes are generally produced after the meeting. More formal minutes are also reviewed after a draft is produced, corrected and signed off before the minutes are finalised.

To handle these scenarios, the system has the three phases outlined above. The system also exports to the project register its meeting minutes at the earliest possible moment where one might have some confidence in the quality of the data within the meeting minutes. This moment occurs when the note taker declares first draft of the minutes is complete, and corresponds with a changing of the meeting phase from ‘Draft’ to ‘Minutes in Review’. If there are any revisions to the meeting minutes during ‘Minutes in Review’, these will be managed by the system using methods outlined later in this section.

Live Exportation: One could configure the system to export a meeting's project item outcomes to the register as soon as they are created within the meeting minute's window. Live exportation so to speak. Curtis et al. (U.S. Pat. No. 8,266,534 B2) uses this design. This method however has a much higher chance of introducing erroneous data into the project register. Consequently, the system defined in this invention waits until the meeting minutes note taker or meeting chair declares that the first draft of the minutes is complete. If the minutes are taken during the meeting and reviewed by the participants synchronously, the minutes might be marked first draft or final at the end of the meeting. Crucially, the system however waits to receive this instruction.

Meeting Item Design Part 6: Exportation Data Validation.

Within a meeting document, only significant input errors will stop a document from being saved to the meeting register. Like all documents, it's imperative that the meeting window only produce an error on absolutely core data. Users need to be able to save their document with minimal restriction.

Whilst the meeting is in the phase “draft”, users can add project item meeting objects without completing the core fields, and nevertheless save their document. Incomplete fields within the objects will raise a warning within the meeting windows validation tab, but will not stop the document being saved. However, before exportation to the project register, these warnings need to be resolved. Without the meeting project item object's core fields being completed, the system would create erroneous data within the project register.

To address this, the system has a method whereby, when the user progresses the meeting from “draft” to “minutes in review”, the system checks to see if there are any errors before it tries to export the data to the project register. If there are warnings on the meeting project item, the meeting will save the meeting with its warnings, and move the meeting into a “half phase” and adjust the system's interface.

In the half phase created by the fact that the meeting document now has errors, the meeting cannot be saved. At this point the user has two options: 1) The user can cancel the exportation and return the document to draft, converting the meeting project item errors back to warnings. Then the meeting can be saved again. Or 2) The user can resolve the errors. Once all the errors are resolved, the user can progress the meeting to ‘Minutes in Review’ and export its project item data to the project register.

Meeting Item Design Part 7: Saving Meeting Items.

When the user instigates the saving method on the meeting time window, if the validation module doesn't flag any errors, the data collected is communicated by the client program, from the users computing device, across the relevant communication network to system's server. The server running on hardware then processes the data and passes it to the database server. The database server, running on the same or different computing hardware, uses the data it has received to create a record of the meeting item in the meeting tables of the system's database.

Meeting Item Design Part 8: User Collaboration.

Once the meeting item has been recorded in the system's database, the record is now visible to other users of the system that have access to the folder to which the meeting item was allocated. Multiple users can now access the same server record, and this allows for synchronous or asynchronous collaboration.

Meeting Item Design Part 9: Meeting Item Reporting.

Meeting items have a variety of output methods. These include, the printed minutes of the meeting, summary of revisions to meetings, detailing of project register item outcomes. Also, utilising an email client, emails with meeting invitations, with agendas or meeting minutes for review can be sent out.

Integration Element 2—Project Register Items Design Overview

To understand how a project item is managed within the system, the core features will be described. Firstly how to create or update a project item will be described then the general features of a project register item will be detailed. Next the life cycle of a Project Register Item and how it lays out its information will be outlined followed by how the system saves a project register item, and consequently enables multi-user collaboration and finally, the details of the reporting options on project register items.

These topics will be covered in parts and in the following order. Project Register Item Design: Part One—Creating Project Items and Updating Project Items. Part Two—General Features of a Project Register Item. Part Three—The life cycle of a project register item. Part Four—Project Register Item Layout Methodology. Part Five—Saving a Project Item. Part Six—Collaboration. Part Seven—Project Register Item Reporting

Project Register Item Design Part 1: Creating/Updating Project Register Items.

Within the system, the creation and updating of project register items is managed by their respective modules. The modules however can be instructed to create items or edit items from various sources, and likewise can be passed data to populate the new item being created. The two sources of instruction are the item's respective project register module and the meeting module.

Project Register Modules—New Project Item: From anywhere within the system, the programs interface allows the user to create a new item within its respective project module.

Project Register Modules—Cloning a Project Item: To clone a project item, the user must go into the relevant project module, select the item to be cloned, and then instruct the project item to clone it. All the details will be the same except the action will have a new unique identifier.

Project Register Modules—Adding an Update: To add an update from the project register modules, the user must go to the relevant project item module, find the project item that they wish to update, open the item, then interacting with the interface, add an update.

Meeting Modules—Creating Project Register Items: Within the meeting item interface, in the Meeting Minutes section, there is a meeting outcome object to create a new project register item, for each project register item type. The outcome object collects all the minimum information required to create an item within the respective project module. When the meeting exports its data, the item is created within the project register.

Meeting Modules—Updating Project Register Items: Within the meeting item interface, in the Meeting Minutes section, there is a meeting outcome object to update each different type of project register item. These objects are different to the ones to create new items within the project register. The outcome update object collects all the minimum information required to update the selected project register item. When the meeting exports its data, the update is added within the project register item.

Project Register Item Design Part 2: General Features.

A project register item's window interface is able to capture a range of information about the project register item. The project register item's interface window runs on the user's computing device, whether a personal computer or mobile device. The window outlines project register item's details and history. The project register item window also has three key functions supporting it: 1) Audit Trail. 2) Attachments. 3) Summary.

Audit Trail: There is an audit support function which keeps a record in a separate database table of every single change made to the project item record, when the change occurred, and by which user. This can be only be viewed by a system administrator, who is then able to audit each individual change made to the project register item.

Project Register Item Support Function 2—Attachments: There is an attachments support function which itemises all the attachments that are associated with any part of the project register item. They are categorised as per their source and can be opened for viewing.

Project Register Item Summary: As the system has contained within its database, an audit record of all the changes that have occurred to a project register item. The next step is to analyse those changes and provide a summary. For example, with an action item, the system provides summary data regarding; the start date, final date, changes to due dates, and the number of times that the responsible for an item has changed, who the original responsible was, and who the current responsible is, how much the item is overdue, and how many times its due date has changed. Each project item records different data, and as such the summary provides a different analysis for each.

Project Register Item Design Part 3—Life Cycle of a Project Register Item

An item has a life cycle that it goes through from when it's created through to when it is cancelled or completed. As an item goes through its life cycle, its current evolution is reflected in its work flow status. The various work flow statuses of a project item are: 1) Draft. 2) Awaiting Acceptance. 3) Open, Re-Assignment Requested. 4) Completion Request Pending, Cancellation Request Pending. 5) Completed. 6) Cancelled.

The key point to note is that updates to the project time that change its details may potentially change the project items workflow status. The workflow status does not in any way impinge on the action item receiving an update from either a meeting or from the project register item itself.

Project Register Item Design Part 4: Layout Methodology.

To layout and present a project item's current and historical information in a coherent and chronological manner, employing a hierarchical structure, there are two main methods that can be used. The first one we will define as ‘Project Item Versioning with Updates’, and the second as ‘Single Project Item with Updates and Audit’. The method used is setup when the system is configured by its administrator.

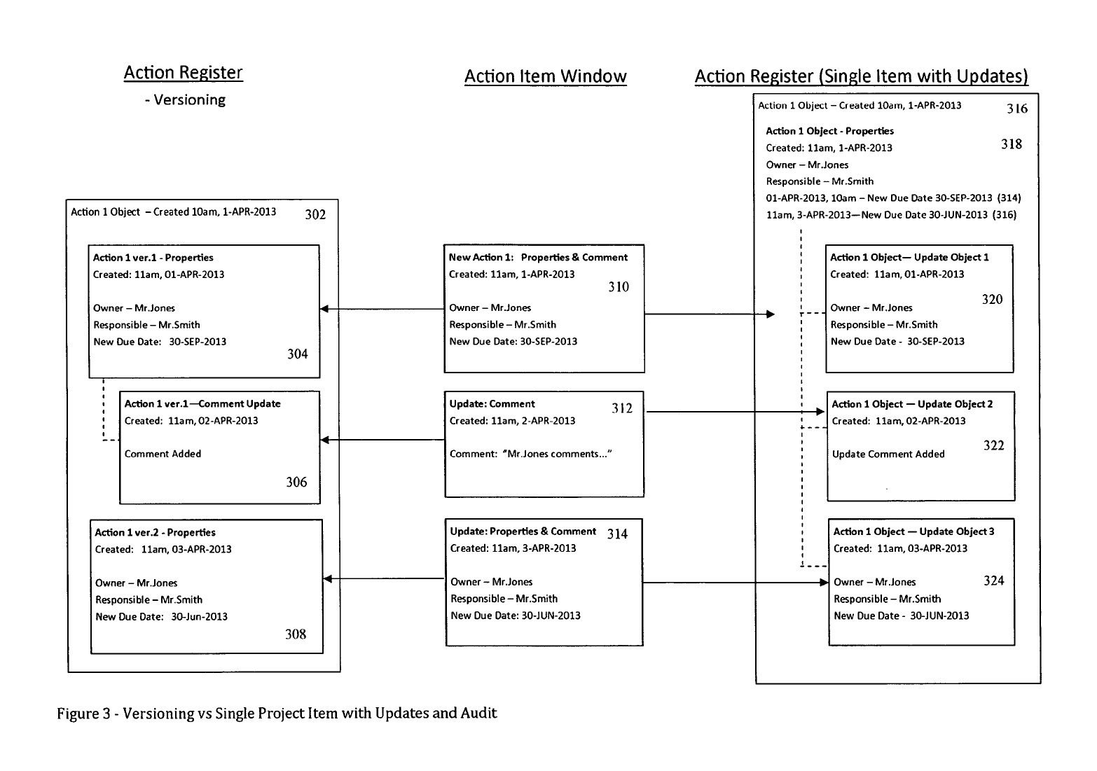

‘Project Item Versioning with Updates’: The premise of this layout method is: An action item using this method needs a new version made if there is a change to the project item's properties. That way, as noted, all progress updates will refer to the right action version. This layout is illustrated by the left hand side of FIG. 3. In this scenario, Mr. Jones creates ‘Action 1’ 310 using the Action Register Item Window, and enters its details. On saving, the system creates the item object ‘Action 1 Object’ 302 in the Action Register and adds the first version of the action ‘Action 1 ver.1—Properties’ 304 that details the items properties. The next day, Mr. Jones adds a progress comment 312 to the action item, which on saving creates a child of 304, the update comment object ‘Action 1 ver.1—Comment Update’ 306. The next day Mr. Jones changes the due date again in the Action Window, 314. On saving, as this update involves a change to the action items details a new version of the item is made. This creates ‘Action 1 ver.2—Properties’ 308.

‘Single Project Item with Updates and Audit’: The premise of this layout method is not quite as mathematically perfect as ‘Project Item Versioning with Updates’, but it is simpler to understand for users, and it provides a good history of an action. There is only one version of the project item, and its properties are continually overwritten if there are any changes from one of its updates that modify its details. In this way the items most recent details are very clear, and the history of evolution can be read in the updates. Finally, any change to the project item's details are also recorded in a dedicated audit record that details exact changes, and by whom.

This layout is illustrated by the right hand side of FIG. 3. In this scenario, Mr. Jones creates ‘Action 1’ 310 using the Action Register Item Window, and enters its details. On saving, the system creates the item object ‘Action 1 Object’ 316 and adds the first update ‘Action 1 Object—Update Object 1’ 320. This update is used to define the items properties 318 The next day, Mr. Jones adds a progress comment 312 in the action window to the action item, which on saving creates a new update ‘Action 1 Object—Update Object 2’ 322. The next day Mr. Jones changes the due date again in the Action Window, 314. On saving, this change creates ‘Action 1 Object—Update Object 3’ 324. This again updates the items properties, 318.

Project Register Item Design Part 5: Saving Project Items.

The saving of project register items is much less complicated than saving a meeting item. The project register item consequently doesn't have a validation support function.

When the project register item receives updates from the meeting item, the update been received has already been checked by the meetings validation.

Updates within the project time are controlled by a pop up window that is used to capture the information to be added. If the pop up window is missing any information, the box will appear red. Until all the items have been completed within the update popup window, the update won't be added to the project register item. Every time an update is successfully added, the project register item is saved back to the project register table.

When the user instigates the saving method on the project register item window, the data collected about the project register item is communicated by the client program, from the users computing device, across the relevant communication network to the system's server. The server running on computing hardware then processes the data and passes it to the database server. The database server running on the same or different computing hardware uses the data it has received to create a record in the system database's relevant table. If the project register item for example is an action item, then a record of the item will be recorded in the system's action tables in the system storage.

Project Register Item Design Part 6: Collaboration.

Once the project register item has been recorded in the system's database, the record is now visible to other users of the system that have access to the folder to which the project register item was allocated. Multiple users can now access the same server record, and this allows for synchronous or asynchronous collaboration.

Project Register Item Design Part 7: Project Register Item Reporting.

Project Register items have a variety of output methods. These include; a printed report of the project register item with its complete history, or a summary version with the most current details. There is a summary report detailing revisions to project item and a statistic summary report. Also, utilising an email client, emails with content reporting on the project register items can be sent out.

Integration Element 2: Project Register Items Design Overview.

Now that the two elements that are being reconciled to each other have been outlined, we will now look at the methodologies required to achieve integration. These will be considered over 4 sections. 1) Methods for data acquisition and sequencing from meetings and their saving into the project register. 2) Methods to sequence updates. 3) Managing the updating problems of project register items. 4) How the system manages meeting revision and represents these changes within the project register.

Integration Methodologies Section 1: Methods for Data Acquisition and Sequencing.

Overview: This section will be discussed in two parts. 1) Saving Meeting Item Outcomes to the Project Register. 2) Sequencing Updates

Saving Meeting Item Outcomes to the Project Register

Saving New Meeting Item Outcomes to the Project Register: When a meeting item exports a new project register item from its minutes, the project register data collected is communicated by the client program, from the users computing device, across the relevant communication network to system's server. The server running on hardware then processes the data and passes it to the database server. The database server, running on the same or different computing hardware, uses the data it has received. The database server will create a new record in the data's respective database tables.

When a meeting item exports a project register update item from its minutes, the project register update data collected, follows the same route as a new project item until it gets to the database server. The database server, analyses the data being received and will open the relevant project item in the project register, and then add an update populating it with the data passed.

Integration Methodologies Section 2: Methods to Sequence Updates

‘Public assignment time’ as a concept is the time and date at which something is publicly declared, with the result being that people might act on or make decisions based on that information. When applied to project items, using the public assignment time to chronologically order elements within a project item enables the item to most closely model the natural workflow of that project item. This makes the data within a project register more accurate.

To enable the use of public assignment time within the system instead of merely creation time, the system orders elements with a project item using a derived time called “Update obtained time” (UOT). There are rules the system follows to ensure that the “update obtained time” most accurately reflects an update's public assignment time. The definitions of these rules are outlined below whilst examining how to address the ‘project/meeting minute integration problems’ outlined in the background section.

Update Sequencing Design Overview: This section outlines the system's solutions to updates problem one, two and three outlined in the background of this document. They will be discussed in the following order: 1) Rule One—Delayed Minute Production (Problem 1). 2) Rule Two—Future Meetings (Problem 2). 3) Rule Three—Multiple Updates from a Meeting (Problem 3).

Before discussing each individual solution, if the system administrator wishes to block the use of future meetings (this is an option within the system), then Solution 1 can be used to sequence updates. Otherwise if future meetings are permissible, then updates should be sequenced using Solution 3. The system can be configured to use Rule 2 as well to sequence it updates, but this layout is has more disadvantages in comparison to the other two.

‘Project/meeting minute integration—problem 1’, detailed in the background section, outlines the need for a project item to accurately handle updates coming from a meeting that has already occurred in the past.

The public assignment time for updates to project items coming from a meeting held in the past, is not their time of exportation from the meeting minutes, it is the time that they were discussed in the meeting. This is best represented by the time and date of the end of the meeting.

Therefore, in the case of problem one, the rules required to define the “update obtained time” and sequence the elements correctly is:

Rule Number 1: All updates from a project time interface, use their creation time for the “update obtained time” (UOT). All updates from a meeting use the meeting end date and time for their “update obtained time” (UOT).

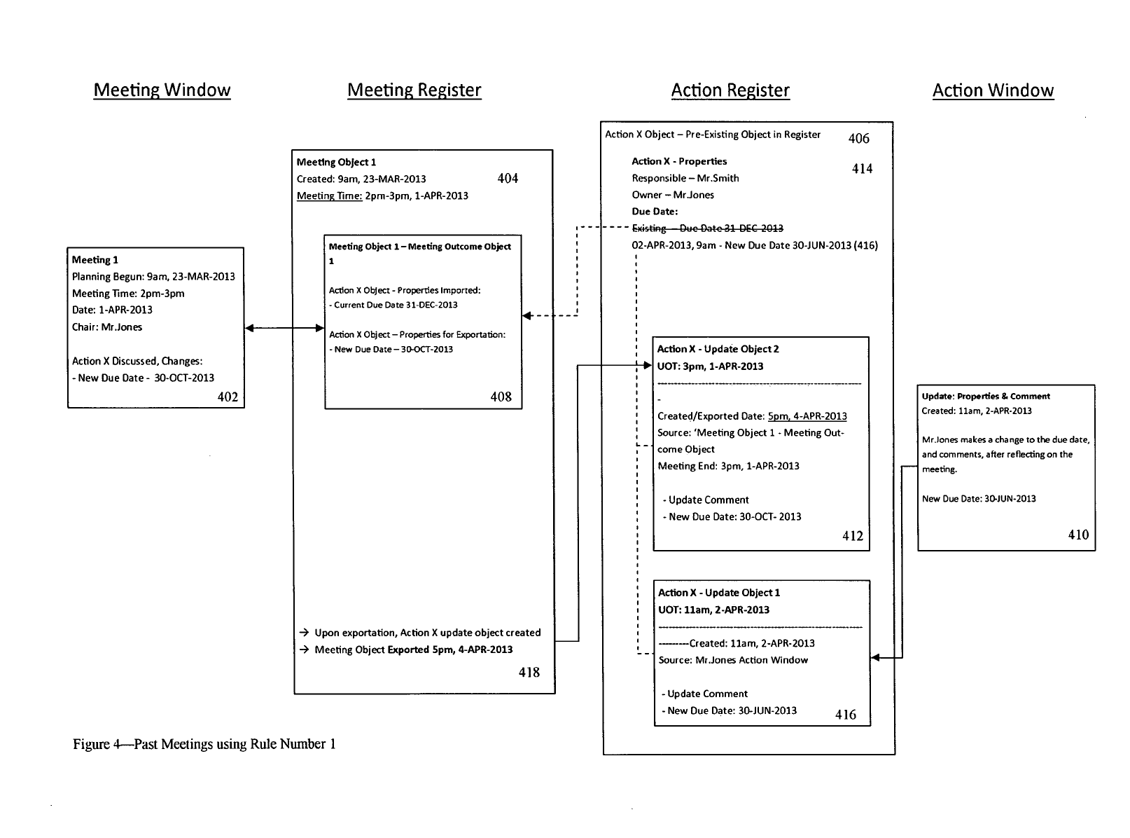

An example of the use of Rule 1 is found in FIG. 4. The Layout Method is ‘Single Project Item with Updates and Audit’. A new meeting 402 is held and recorded in the system as Meeting Object 1 404. An existing Action Item ‘Action X Object’ 406 is imported into the agenda of the meeting and is recorded as ‘Meeting Object 1—Meeting Outcome Object 1’ 408. As a result of discussions during the meeting, it is agreed that ‘Action X Object’ 406 will be assigned the new date of the 30-OCT-2013. This change is recorded in ‘Meeting Object 1—Meeting Outcome Object 1’ 408 and becomes part of the draft minutes of the meeting. No change will be made to the ‘Action X object’ 406 until the contents of the minutes are exported.

Mr Jones decides the following day, before the meeting minutes are ready, and their stored information is exported to the Action Register that he needs to change the due date of the Action Item to 30-JUN-2013. He does this using the Action Item Window 410. This creates ‘Action X Object—Update Object 1’ 416 within ‘Action X Object’ 406 with a due date of 30-JUN-2013. Using Rule 5; the creation of update 416 updates ‘Action X Object-Properties’ 414, changing the due date from the 31-DEC-2013 to 30-JUN-2013.

Subsequently, the meeting minutes are exported to the Action Item Register 418 on 4-APR-2013. This creates within the item 406, the new update ‘Action X Object—Update Object 2’ 412. Using Rule 1, it receives the ‘Update Obtained Time’ from the meeting's end time and date. This places the update in the item before the update by 416. Using Rule 5, the creation of update 412 will not update the actions details in 414 as it is not the most recent update.

When the Action Item is viewed in the system, the correct due date will be displayed, the 30-JUN-2013.

Project/meeting minute integration—problem 2, detailed in the background section, outlines the need for a project register item to sequence accurately updates being exported from meeting minutes, for a meeting that is planned for the future.

As future meetings are somewhat of an abstract concept for users, the use of future meetings is optional within the system. It is one of the system's preferences. If the option to disable future meetings is selected, the system will not allow updates to be passed from the meeting item to their corresponding project register items until the meeting end time has passed. If future meetings are allowed, then this feature needs to be handled correctly.

When the meeting minutes of a future meeting exports its data to the project register, creating new project items, or project item updates, this is when the contained information becomes publicly available. When this exportation occurs is consequently the public assignment time.

Therefore, in the case of ‘problem two’, the rules required to define the “update obtained time” and sequence the elements correctly is:

Rule number 2: All updates from the Project Item interface use their creation time for the “update obtained time (UOT)”. All updates from a future meeting use the meeting end date and time for their “update obtained time” (UOT).

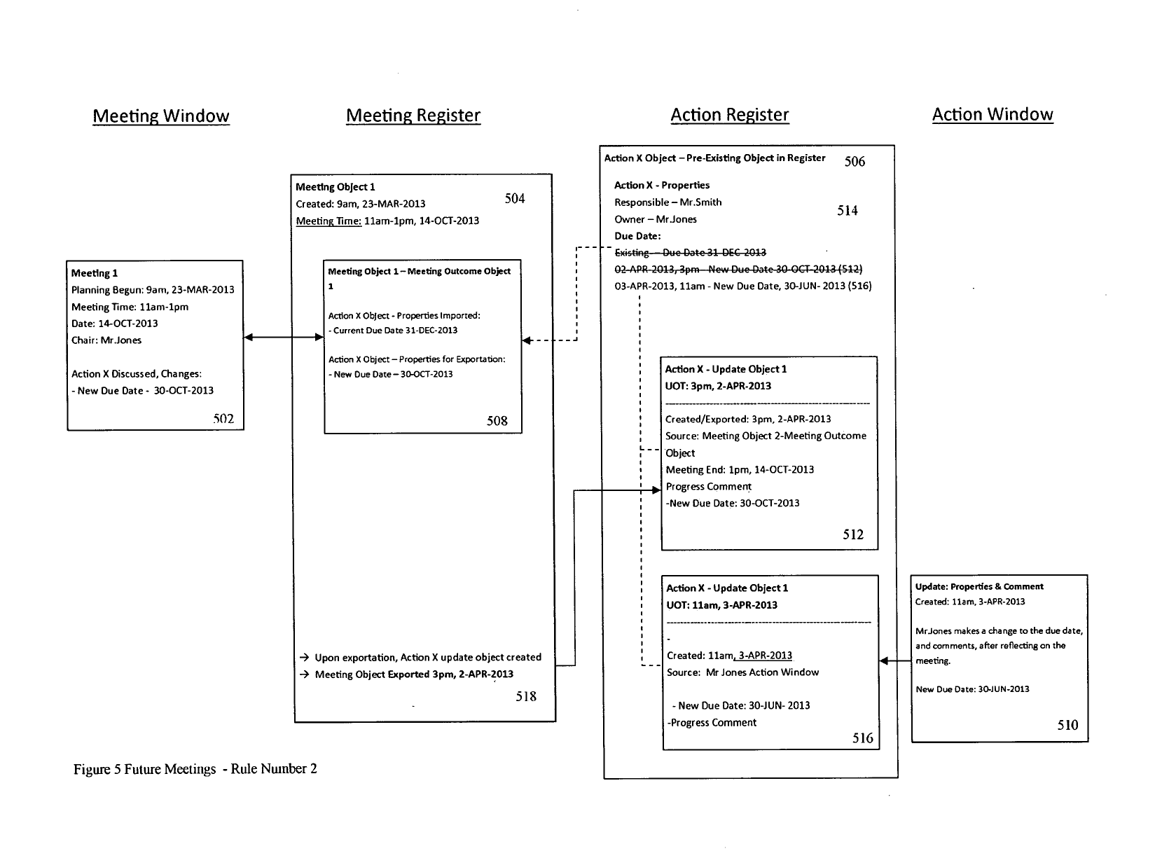

An example of the use of Rule 2 is found in FIG. 5 Future Meetings. The Layout Method is ‘Single Project Item with Updates and Audit’. A new meeting 502 is created and recorded in the system as Meeting Object 1 504. An existing Action Item ‘Action X Object’ 506, has its properties 514 imported into the agenda of the meeting and is recorded as ‘Action X Object 1—Meeting Outcome Object 1’ 508. In drafting the minute for the future meeting, the minute taker decides that ‘Action Object X’ 506 will be assigned the new due date of the 30-OCT-2013. This change is recorded in ‘Meeting Object 1—Meeting Outcome Object 1’ 508 and becomes part of the draft minutes of the meeting. The meeting's minutes are exported 518 to the Action Register Item on 2-APR-2013 creating the update ‘Action X Object—Update Object 1’ 512 before the meeting has occurred (planned for the 14-OCT-2013). Using Rule 2, the update 512 receives the “update obtained time” (UOT) that is the same as the export time. Using Rule 5, the creation of update 512 will update the actions details 514 as it is the most recent update. The Due date will change from the 31-DEC-2013 to 30-OCT-2013.

Mr Jones decides the following day that he needs to change the due date of the Action Item to 30-JUN-2013. He does this using the Action Item Window 510. This creates ‘Action X Object—Update Object 2’ 516 within ‘Action X Object’ 506 with a due date of 30-JUN-2013. Using Rule 5; the creation of update 516 updates ‘Action X Object—Properties’ 514, changing the due date from the 30-OCT-2013 to 30-Jun-2013.

When the Action Item is viewed in the system, the correct due date will be displayed, the 30-JUN-2013.

Given that the rules for past meeting and future meetings contradict each other, the system needs to be designed to accurately manage past and future meetings if the system is configured by the system administrator to manage both.

The solution to this problem is as follows. Combining solutions to problem 1 and problem two, the public assignment time can be established by resolving which is earlier. Either, the future meeting date, or the update's exportation/creation date. For all updates for future meetings, the earlier date will be the creation date, and for past meetings it will be the meeting end time.

Therefore, in the case of trying to address ‘problem one and two’, the rules required to define the “update obtained time” and sequence the elements correctly are:

Rule number 3: All updates from a project item interface use their creation time for the “update obtained time (UOT)”. All new items or updates from a meeting, use the earlier of either the meeting end time and date or its exportation/creation time and date, to define the “update obtained time” (UOT).

An example of how the system would manage a past meeting would be the same as FIG. 4, and how it would manage a future meeting is the same as FIG. 5.

Project/meeting minute integration—problem 3, detailed in the background section, outlines the need for a project item to handle accurately multiple updates coming from one meeting.

As the updates come from the same meeting, they all receive the same “update obtained time”. Consequently, the system needs an additional parameter to accurately sequence them in the project item's history. Conceptually they need to be sequenced as per their order in the meeting. This is important as the most up to date discussion about an item is the last one.

To sequence the updates, the system therefore imports with the update its meeting project item object sequence number. This is a number assigned to each project item update within the meeting that is dynamically maintained by the meeting interface. The number is from lowest to highest, with the lowest number correlating with the earliest item in the meeting, and the highest number correlating with the last item in the meeting. As the numbers are dynamically maintained, if you reorder the project item updates within the meeting, they receive a new sequence number. This technique applies equally to the hierarchical method, or the free-form text with embedded hierarchical project item update objects.

Therefore, in the case of trying to address ‘problem three’, the rules required to define the “update obtained time” and sequence the elements correctly are:

Rule number 4: All updates from a project item interface use their creation time for the “update obtained time (UOT)”. All new items or updates from a meeting, uses the earlier of either the meeting end time and date or its exportation/creation time and date to define the “update obtained time” (UOT). A meeting sequence number for each meeting project item update is used to order the corresponding updates in the Project Item, from earliest to latest as per meeting time.

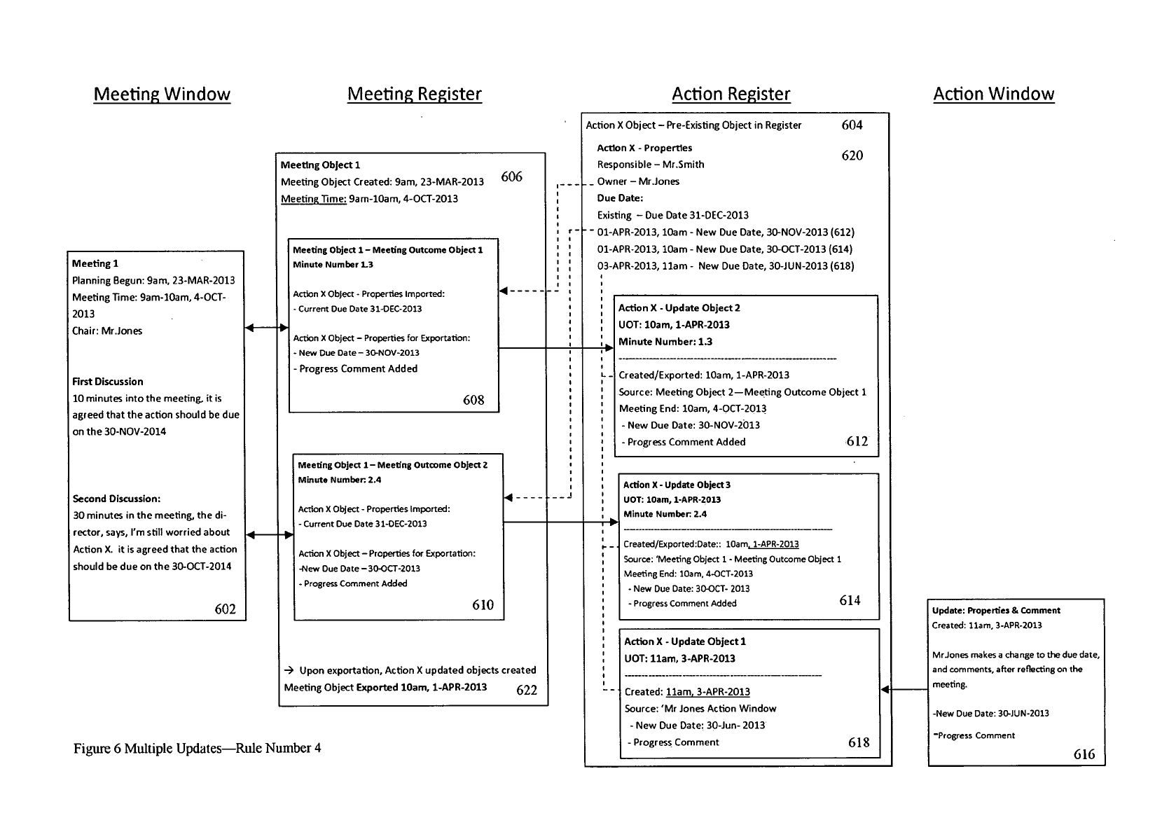

An example of the use of Rule 4 is found in FIG. 6 Multiple Updates. The Layout Method is ‘Single Project Item with Updates and Audit’. In this figure, a Meeting 602 is being planned (on the 23-MAR-2013) for a future meeting to be held on the (4-OCT-2013). During this meeting the action Item ‘Action X Object’ 604 will be discussed twice under two different agendas. Each section needs the ability to record the discussion and reflect changes to the same Action Item during that part of the meeting. To achieve this, ‘Meeting Object 1’ 606 imports the properties of the action item twice as per user instruction from the system's interface and they are recorded within the meeting object as meeting outcome objects 608, 610. Required changes to the action item during each part of the meeting are reflected in these objects. The minutes are prepared and its relevant contents are exported 622 to the project register at 10 am on the 1-APR-2013. The action item ‘Action X Object’ 604 will receive the updates 608, 610 and using Rule 4 will allocate them the same Update Obtained Time and sequence them as per their order in the meeting object 606. The Meeting Outcome 608 and 610 will correspond with the ‘Action X Object’ 604 Updates 612 and 614 respectively. As per Rule 5, this updates the properties 620, of Action Item 604, and updates the items due date property twice, changing first to the 30 NOV-2013 and then to 30-OCT-2013.

Mr. Jones at 11 am on the 03-APR-2013 then decides to change the due date of the Action item 604 again, and using the Action Window 616 creates a new action item update ‘Action X Object—Update Object 1’ 618 and sets the due date as the 30-JUN-2013. As per Rule 5, this updates the properties 620, of Action Item 604, and the due date from the 30 OCT-2013 to 30-JUN-2013.

When the Action Item is viewed in the system, the correct due date will be displayed, the 30-JUN-2013.

Integration Methodologies: Section 3 Minute Revision Design

Section 3 Overview—Minute Revision Design: As outlined in the background section, the system needs to be able to handle changes to the meeting minutes and appropriately update their related content within the project register.

The system has been configured to use any one of the four methods outlined below. Each has its advantages and disadvantages, and ultimately the decision on which to use comes down to user preference. Method One: Overwriting whilst keeping the Update Obtained Time. Method Two: Append the progress Updates. Method Three: Updates as Children. Method Four: New Version of the Update Sequentially Ordered. Method Five Cancelled Meetings.

All of these methods can be applied to the project item being configured to use the layout methodology ‘project item versioning with updates’ or ‘single project item with updates and audit’.

In considering the following scenarios, a revision to the meeting minutes has included a revision to a meeting project register item outcome. Upon the system saving the changes to the meeting, the meeting interface realises that there has been a change to a meeting project register item outcome, and then exports the new version of the outcome to its respective item in the project register. The project register item then needs to handle the update appropriately using methods one to four.

There are several ways that minute revision changes can be represented within a project item, but whichever method is selected, it is imperative that the system achieve three points. Firstly, the minute revision can't affect or overwrite or interfere with other updates. Secondly, if there have been no updates from another source since the meeting, and if the revision contains changes to the project item's details, then this change needs to be represented as the project item's most recent item details. Thirdly, the changes effected by the meeting minute revision need to be shown in the project item in such a way as to facilitate understanding of the item's history.

Finally this section will also outline what happens to project items within a project register that were sourced from a meeting, in the event that the source/contributing meeting is cancelled.

Meeting Revision: Method One, Overwriting whilst keeping the Update Obtained Time.

In this Method, the existing updates within the project items are overwritten with the revised meeting project item updates that are been exported from the revised minutes. The new update objects are given the same “update obtained time” as the object it is replacing, thereby protecting the chronological order of elements. This is important with future meetings where the creation date is used for the update obtained time.

The advantage of this method is its simplicity. The disadvantage of this method is that subsequent updates that related to the one being replaced may no longer make sense. Additionally, within the new project item you can't see the change that was made from the old update.

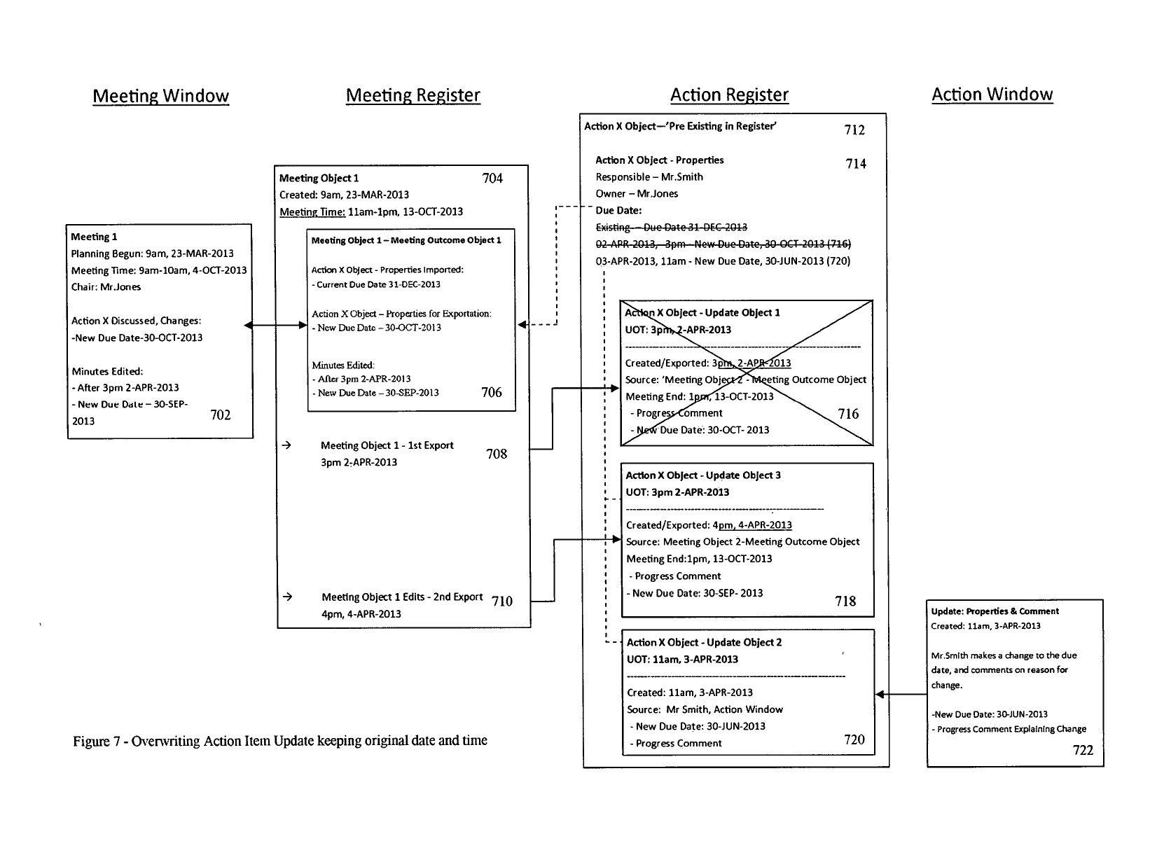

A worked example of this scenario can be found in FIG. 7 ‘Overwriting Action Item Update keeping original date and time’. The Layout Method is “Single Project Item with Updates and Audit’. The scenario is of a future meeting, as it is an abstract concept, and is more complicated for the system to handle. A new future meeting 702 is planned and created in the system as ‘Meeting Object 1’ 704. Mr. Jones is the meeting chair and is also taking the meeting minutes. An existing Action Item, ‘Action X Object’ 712 has its details/properties 714 imported into the agenda of the meeting, and these details are recorded as ‘Action X Object 1—Meeting Outcome Object 1’ 706. The meeting minutes are made by Mr. Jones for the future meeting and the meeting outcome 706 is assigned the new date of the 30-SEP-2013. Upon Mr. Jones's direction, 3 pm, 2-APR-2013, ‘Meeting Object 1’ 704 exports 708 its relevant changes to the ‘Action X Object’ 712 creating the update ‘Action X Object—Update Object 1’ 716. As per Rule 5, this in turn updates the ‘Action X Object—Properties’ 714, changing the due date from 31-DEC-2013 to the 30-OCT-2013.

Mr. Smith, the responsible for the action, decides the following day that the due date of the Action Item should be the 30-JUN-2013. He makes this change directly in the Action Register Item, using the Action Item Window 722, he also comments as to why he made the change. Upon completing this process, the update ‘Action X Object—Update Object 2’ 720 is created. As per Rule 5, this in turn updates the ‘Action X Object—Properties’ 714, changing the due date from the 30-OCT-2013 to the 30-JUN-2013.

On following day, on the 4-APR-2013, Mr. Jones realises that he has made a typing error in the minutes that he wrote on the 2-APR-2013, two days earlier. The date he had intended to write down was the 30-SEP-2013. He accordingly edits the meeting minutes, and this revision is reflected in a change to the ‘Meeting Object 1—Meeting Outcome Object 1’ 706. Mr. Jones saves these meeting changes, at which time, the system then exports 710 the revised meeting outcome 706 to the relevant action item 712. This change is to the existing update object, ‘Action X Object—Update Object 1’ 716. Using Method 1, the update object 716 is replaced using the new information coming from the meeting, by creating ‘Action X Object—Update Object 3’ 718. The update object 718 retains the UOT of the previous object 716. This avoids the new update 718 being incorrectly ordered. If it was to get a new Update Obtained Time, as it is updating a future meeting, the UOT would be the export time and date, which would now be after the update object 720. As per Rule 5, update 718 does not become the most recent update, and no change is made to ‘Action X Object—Properties’ 714.

In FIG. 7, using Method 1 the final due date of ‘Action X Object’ 712 is 30-JUN-2013.

Meeting Revision: Method Two, Append the Progress Updates.

In this scenario, the new update being passed from the meeting is appended in text form to its relevant project item update, that already exists within the project item that is being updated. Alternatively, configured by a system setting, the inverse can be done, with the old update becoming embedded text of new update.

The advantage of this method is that both the previous update from the meeting, and the current update with the revised minutes can be seen when reading the project item's history. The disadvantage of this method is that you can end up with particularly large objects outlining the changes to an update distracting from the update of the system.

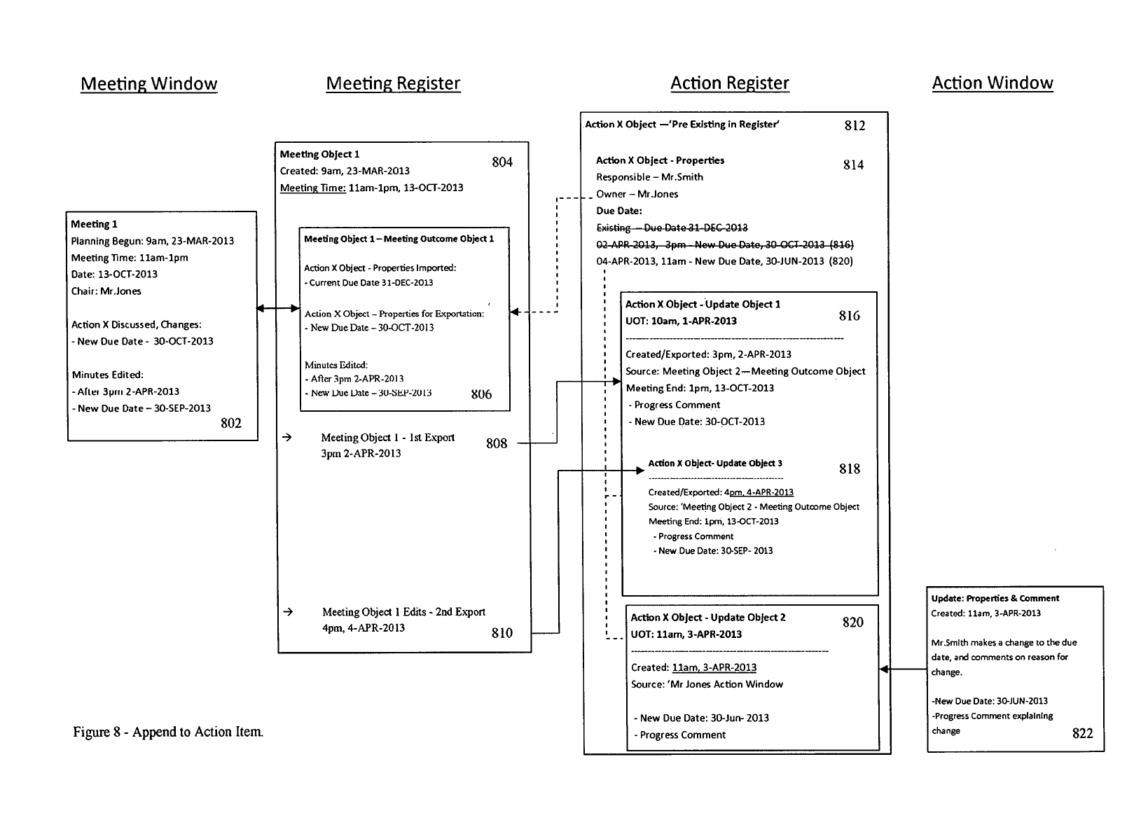

A worked example of this scenario can be found in FIG. 8 ‘Overwriting Action Item Update keeping original date and time’. The Layout Method is “Single Project Item with Updates and Audit’, and the system is configured with the new updates becoming children of the old update. The scenario is of a future meeting, as it is an abstract concept and is more complicated for the system to handle. A new future meeting 802 is planned and created in the system as ‘Meeting Object 1’ 804. Mr. Jones is the meeting chair and is also taking the meeting minutes. An existing Action Item, ‘Action X Object’ 812 has its details/properties 814 imported into the agenda of the meeting, and these details are recorded as ‘Action X Object 1—Meeting Outcome Object 1’ 806. The meeting minutes are made by Mr. Jones for the future meeting and the meeting outcome 806 is assigned the new date of the 30-SEP-2013. Upon Mr. Jones's direction, 3 pm, 2-APR-2013, ‘Meeting Object 1’ 804 exports 808 its relevant changes to the ‘Action X Object’ 812 and creates the update ‘Action X Object—Update Object 1’ 816. As per Rule 5, this in turn updates the ‘Action X Object—Properties’ 814, changing the due date from 31-DEC-2013 to the 30-OCT-2013.

Mr. Smith, the responsible for the action, decides the following day that the due date of the Action Item should be the 30-JUN-2013. He makes this change directly in the Action Register Item, using the Action Item Window 822, he also comments as to why he made the change. Upon completing this process, the update ‘Action X Object—Update Object 2’ 820 is created. As per Rule 5, this in turn updates the ‘Action X Object—Properties’ 814, changing the due date from the 30-OCT-2013 to the 30-JUN-2013.

On following day, on the 4-APR-2013, Mr. Jones realises that he has made a typing error in the minutes that he wrote on the 2-APR-2013, two days earlier. The date he had intended to write down was the 30-SEP-2013. He accordingly edits the meeting minutes, and this revision is reflected in a change to the ‘Meeting Object 1—Meeting Outcome Object 1’ 806. Mr. Jones saves these meeting changes, at which time, the system then exports 810 the revised meeting outcome 806 to the relevant action item 812. This change is to the existing update object, ‘Action X Object—Update Object 1’ 816. Using Method 2, the update object 816 has the new update from the meeting ‘Action X Object—Update Object 3’ 818 written into its description field for historical reference.

In FIG. 8, using Method 2 the final due date of ‘Action X Object’ 812 is 30-JUN-2013.

Minute Revision: Method Three, Updates as Children

In this scenario, the new update being passed from the meeting is linked to the existing project item update using a parent-child relationship. Consequently, the new update becomes a child of the existing update. Alternatively, configured by a system setting, the inverse can be done, with the old update becomes a child of the new one. This process can be repeated, and old updates would be ordered sequentially descending newest to oldest.

In this way, both the previous updates from the meeting and the current update with the revised minutes can be easily seen when reading the project item's history.

Alternative Order: The system can be configured to order the child updates in the reverse order as well, where the new updates become children of the original update.

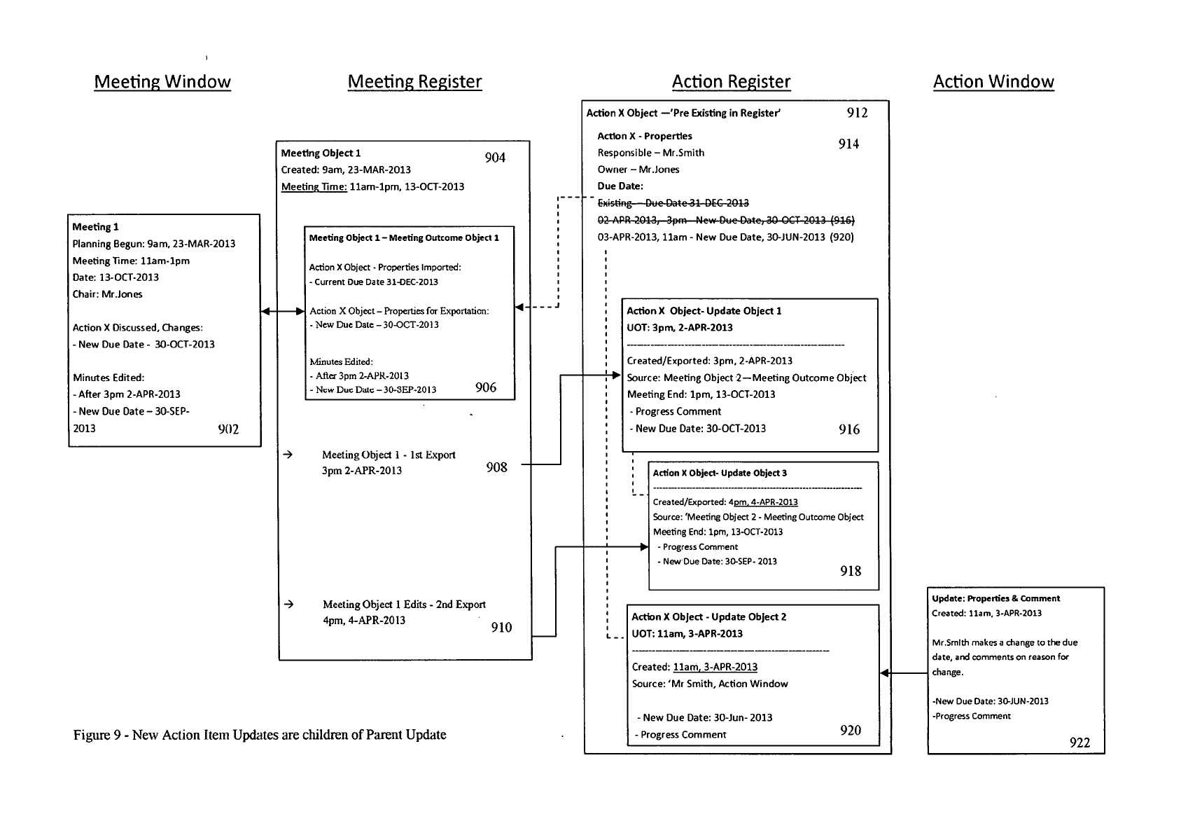

A worked example of this scenario can be found in FIG. 9 ‘Overwriting Action Item Update keeping original date and time’. The Layout Method is “Single Project Item with Updates and Audit’, and the system is configured with the new updates becoming children of the old update. The scenario is of a future meeting, as it is an abstract concept, and is more complicated for the system to handle. A new future meeting 902 is planned and created in the system as ‘Meeting Object 1’ 904. Mr. Jones is the meeting chair and is also taking the meeting minutes. An existing Action Item, ‘Action X Object’ 912 has its details/properties 914 imported into the agenda of the meeting, and these details are recorded as ‘Action X Object 1—Meeting Outcome Object 1’ 906. The meeting minutes are made by Mr. Jones for the future meeting and the meeting outcome 906 is assigned the new date of the 30-SEP-2013. Upon Mr. Jones's direction, 3 pm, 2-APR-2013, ‘Meeting Object 1’ 904 exports 908 its relevant changes to the ‘Action X Object’ 912 creating the update ‘Action X Object—Update Object 1’ 916. As per Rule 5, this in turn updates the ‘Action X Object—Properties’ 914, changing the due date from 31-DEC-2013 to the 30-OCT-2013.

Mr. Smith, the responsible for the action, decides the following day that the due date of the Action Item should be the 30-JUN-2013. He makes this change directly in the Action Register Item, using the Action Item Window 922, he also comments as to why he made the change. Upon completing this process, the update ‘Action X Object—Update Object 2’ 920 is created. As per Rule 5, this in turn updates the ‘Action X Object—Properties’ 914, changing the due date from the 30-OCT-2013 to the 30-JUN-2013.

On following day, on the 4-APR-2013, Mr. Jones realises that he has made a typing error in the minutes that he wrote on the 2-APR-2013, two days earlier. The date he had intended to write down was the 30-SEP-2013. He accordingly edits the meeting minutes, and this revision is reflected in a change to the ‘Meeting Object 1—Meeting Outcome Object 1’ 906. Mr. Jones saves these meeting changes, at which time, the system then exports 910 the revised meeting outcome 906 to the relevant action item 912. This change is to the existing update object, ‘Action X Object—Update Object 1’ 916. Using Method 3, the new update ‘Action X Object—Update Object 3’ 918, becomes a child of update 916. As per Rule 5, this update 918 does not become the most recent update, and no change is made to ‘Action X Object—Properties’ 914.

In FIG. 9, using Method 3 the final due date of ‘Action X Object’ 912 is 30-JUN-2013.

Minute Revision: Method Four, New Version of the Update Sequentially Ordered

In this scenario, the new update being passed from the meeting produces a new version of the update, which is then located immediately after the update that it is correcting. The updates would be added sequentially, have the same Update Obtained Time, but be sequenced as per its update revision chronology in order.

There is no distinct advantage of this method over making the new updates/old updates children of each other. The disadvantage of this method is that at first glance, it looks like there have been a lot more updates to the project item than there actually was. As such, you need to look carefully to establish which is a new update, and which is a revision of an old update.

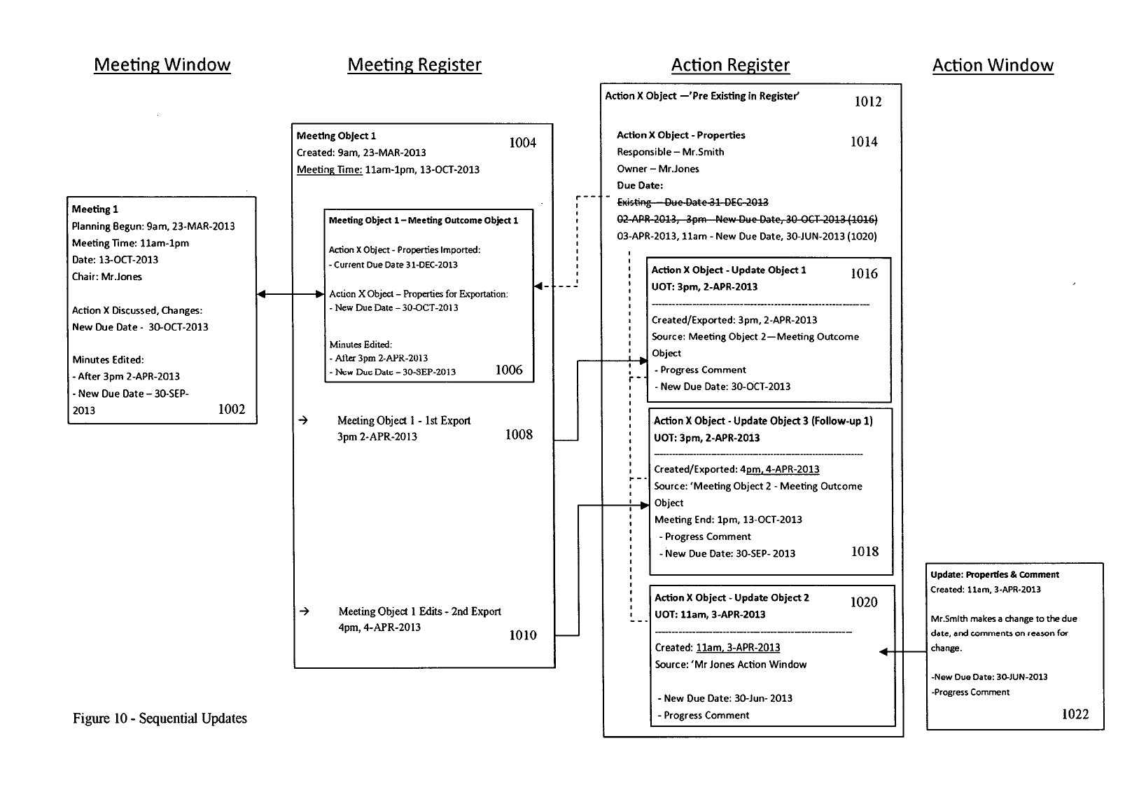

A worked example of this scenario can be found in FIG. 10 ‘Overwriting Action Item Update keeping original date and time’. The Layout Method is “Single Project Item with Updates and Audit’. The scenario is of a future meeting, as it is an abstract concept, and is more complicated for the system to handle. A new future meeting 1002 is planned and created in the system as ‘Meeting Object 1’ 1004. Mr. Jones is the meeting chair and is also taking the meeting minutes. An existing Action Item, ‘Action X Object’ 1012 has its details/properties 1014 imported into the agenda of the meeting, and these details are recorded as ‘Action X Object 1—Meeting Outcome Object 1’ 1006. The meeting minutes are made by Mr. Jones for the future meeting and the meeting outcome 1006 is assigned the new date of the 30-SEP-2013. Upon Mr. Jones's direction, 3 pm, 2-APR-2013, ‘Meeting Object 1’ 1004 exports 1008 its relevant changes to the ‘Action X Object’ 1012 creating the update ‘Action X Object—Update Object 1’ 1016. As per Rule 5, this in turn updates the ‘Action X Object—Properties’ 1014, changing the due date from 31-DEC-2013 to the 30-OCT-2013.

Mr. Smith, the responsible for the action, decides the following day that the due date of the Action Item should be the 30-JUN-2013. He makes this change directly in the Action Register Item, using the Action Item Window 1022, he also comments as to why he made the change. Upon completing this process, the update ‘Action X Object—Update Object 2’ 1020 is created. As per Rule 5, this in turn updates the ‘Action X Object—Properties’ 1014, changing the due date from the 30-OCT-2013 to the 30-JUN-2013.

On following day, on the 4-APR-2013, Mr. Jones realises that he has made a typing error in the minutes that he wrote on the 2-APR-2013, two days earlier. The date he had intended to write down was the 30-SEP-2013. He accordingly edits the meeting minutes, and this revision is reflected in a change to the ‘Meeting Object 1—Meeting Outcome Object 1’ 1006. Mr. Jones saves these meeting changes, at which time, the system then exports 1010 the revised meeting outcome 1006 to the relevant item action item 1012. This change is to the existing update object, ‘Action X Object—Update Object 1’ 1016. Using Method 4, the ‘Action X Object—Update Object 3’ 1018 is sequenced immediately after the update that it's updating 1016, and obtains the same Update Obtained Time and is sequenced as per its update revision chronology in order (+1 each addition update). As per Rule 5, the update 1018 does not become the most recent update, and no change is made to ‘Action X Object—Properties’ 1014.

In FIG. 9, using Method 3 the final due date of ‘Action X Object’ 1012 is 30-JUN-2013.

Minute Revision: Method 5 Cancelled Meetings.

If a meeting is cancelled, two things happen. When the system is using the layout methodology ‘Project Item Versioning with Updates’ for its project item, then the system automatically adds a progress update, sequenced with its time of creation. The progress note explains that the contributing meeting was cancelled. The original progress update that came from the cancelled meeting, details its source. This source label would now additionally have the note “Meeting Cancelled” added to it. When the system is using the layout methodology ‘Project Item Versioning with Updates’, any update from any meeting has its source noted, and the additional comment “Meeting Cancelled” is again added to that note. In either layout methodology, the system does not automatically remove the content, or change the project items details in anyway. From a user perspective, the system merely flags that a contributing source for the project item has been cancelled. The user can then cancel the project item if they need to.

Integration Methodologies: Section 4—Project Item Detail Revision

Project register items contain the entire chronological history of the item, but often the system only needs to present the most recent data. How the system's two layout methodologies maintain the most recent project item data is different. This will now be outlined for both. In order: 1) Rule 5—Single project Item with updates and audit. 2) Project item versioning with updates

Single Project Item with Updates and Audit.

In the case of ‘Single project Item with updates and audit’ the project item only has one copy of the project item's details. Each new update that the project register item receives will be added to the items history. The project register item must also consider whether it will amend the project item's details using the data contained within the new update. The rule to establish whether the properties of the project item will change is:

Rule number 5: IF ((The exported update is more than just a comment, and contains details to update the project item's properties) AND (The project item's update that is being updated has the most recent “update obtained time”)) THEN (Update the project item's properties and make a record of the changes in the properties audit table.)

Project Item Versioning with Updates.

In the case of ‘project item versioning with updates’ the system uses the most recent project item version to obtain the most recent details. If a meeting update is to an old version of the item, this won't affect the most recent version and therefore won't affect the item's details used by the system.

Integration Methodology Summary.

Technical solutions have now been outlined to the major issues identified in the background section, that need to be addressed when integrating meeting minutes with a project register. Within each part of these solutions, there were certain options that were offered that would allow customization of the system as per the system manager's preference.

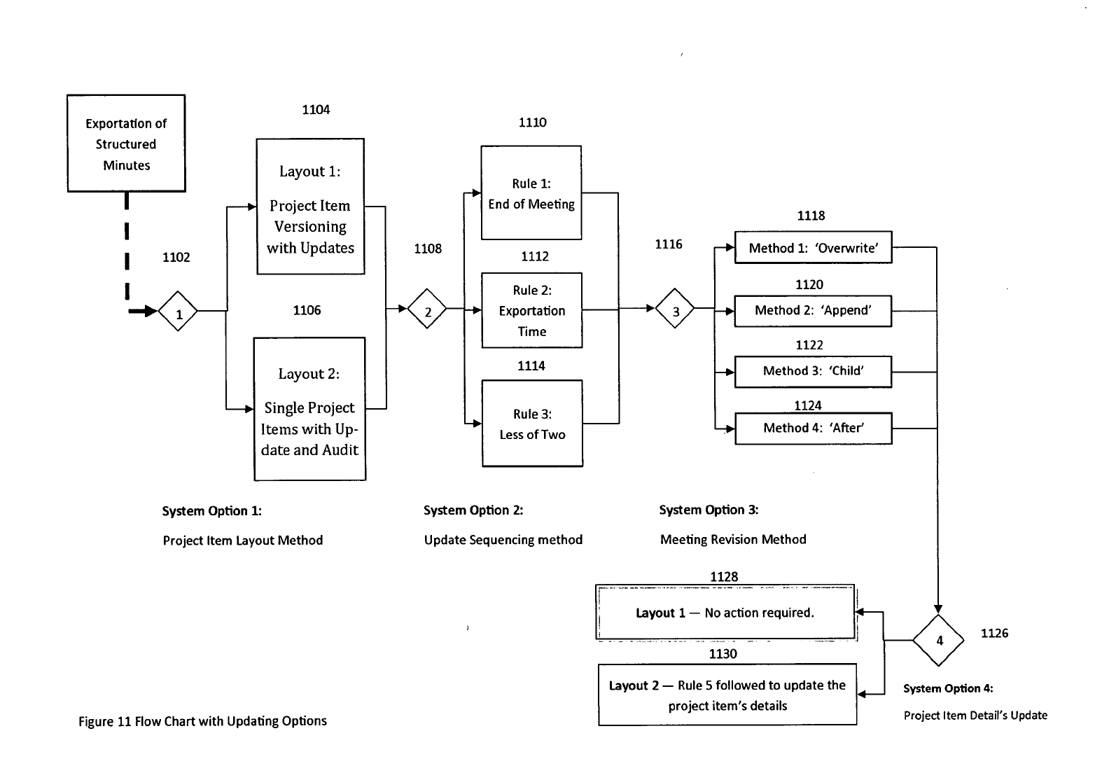

These options build on each other and are laid out in FIG. 11. In the figure, at 1102 the project register items receives an update containing data collected from a meeting outcome with data for the creation of a new project item, or with data to add an update to an existing project time. In the system settings, the layout of the project item will be configured to use either 1104-Layout 1, or 1106 Layout 2. At 1108, if the data being received is an update, then the updates will then be sequenced as per 1110-Rule 1. 1112-Rule 2, 1114-Rule 3 that were previously outlined. Multiple Updates from a meeting are all managed the same way using Rule 4, and is not an option and therefore not in FIG. 11. 1116, The next option a project item has to configure its history is how it wants to display revisions to meeting minutes. The project item can be instructed to use 1118-Method 1, 1120-Method 2, 1122-Method 3, 1124-Method 4. These have all been previous outlined. At 1126, finally, for project items that use 1106-Layout 2, the system will use Rule 5 to update its project item details. This is not an option, but is listed to outline Rule 5 doesn't not apply to 1104-Layout 1.

System Productivity and Analysis.

With the integration issues resolved between meeting minutes and project items, it is consequently possible to use the system capture key data more efficiently, and then report against it. The document will briefly discuss two of these possibilities, in order: Part 1—Update Meetings. Part 2—Reporting and Analysis.

Reporting Part 1: Update Meetings

The premise of these meetings is that you can select from the project register multiple project items that one wishes to discuss, and then automatically generate an ‘update meeting’ around those item. Upon command, the system will import the details of each project item selected into a meeting minutes window. It will then organise each item under agenda items. The allocation to an agenda item can be based on any common criteria to the project items, but the system but by default the system users folder location to label the agenda headings.

Each imported project item can be updated. That is, its project item's details can be modified, and progress updates can be added. When the meeting window is instructed, it will export the captured data back to the project register. The system will then add the respective updates to the relevant project items using the methodologies outlined in this invention.

The power of ‘update meetings’ is you can then run update meeting for a range of different scenarios. One could for example select all the outstanding actions and issues for a staff member and run an update meeting with that staff member only. One could run an update meeting for all items within a folder. One could run an update meeting for all high priority actions, issues, risks, etc.

Reporting Part 2: Analysis

With the meeting and the project register captured in the system's database, it then becomes possible to do more in-depth analysis of the systems content. Examples include: Reports that outline all overdue project items, with sub criteria such as ‘which have the priority: critical’, or ‘belong to a certain team/person’. Reports that detail all the actions that are due in the next day, week, or months. A report on all the decisions that were taken for a certain part of the project. A list of all the current risks facing the project with the sub criteria ‘high’.

Illustrative System for Managing a Meeting.

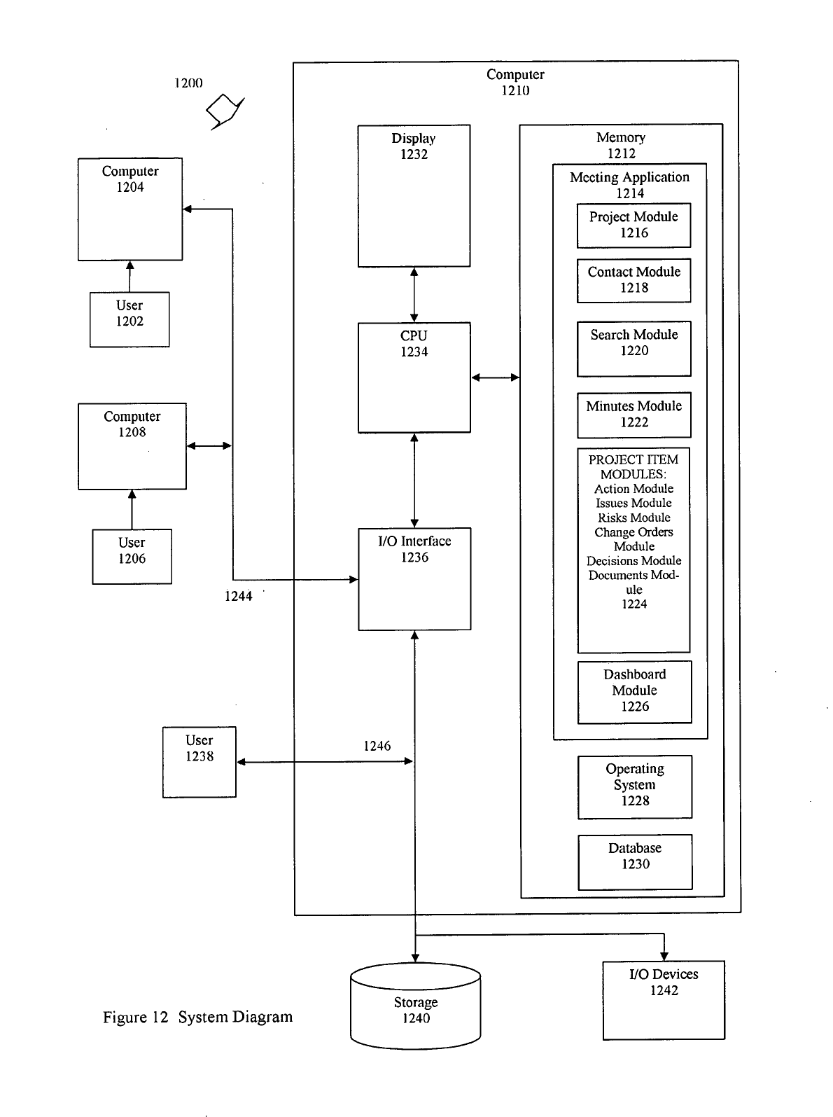

Turning to the drawings, FIG. 12 shows an illustrative system 1200 for managing a meeting. In particular, a user, such as user 1238, can schedule a meeting with users 1202 and 1206 and create an agenda for the meeting. The meeting can comprise a traditional face to face meeting, a meeting conducted over a network (e.g., online meeting), or the like. In the latter case, users 1238, 1202 and 1206 can conduct the meeting by using computers 1204, 1208 and 1210 to communicate with one another. Communications can comprise audio, video, data or any combination thereof, and can occur over a network 1244. To this extent, network 1244 can comprise any type of communications link. For example, network 1244 can comprise an addressable connection in a client-server (or server-server) environment that may utilize any combination of Wireline and/or wireless transmission methods. In this instance, computers 1204, 1208 and 1210 may utilize conventional network connectivity, such as Token Ring, Ethernet, WiFi or other conventional communications standards. Further, network 1244 can comprise any type of network, including the Internet, a wide area network (WAN), a local area network (LAN), a virtual private network (VPN), etc. Where computers 1204, 1208 and 1210 communicate via the Internet, connectivity could be provided by conventional TCP/IP sockets-based protocol, and one or more computers 1204, 1208 and 1210 could utilize an Internet service provider to establish connectivity.

As shown, computer 1210 generally includes a central processing unit (CPU) 1234, a memory 1212, an input/output (I/O) interface 1236, a bus 1246, external I/O devices/resources 1242, and a storage unit 1240. CPU 1234 may comprise a single processing unit, or be distributed across one or more processing units in one or more locations, e.g., on a client and server. Memory 1212 may comprise any known type of data storage and/or transmission media, including magnetic media, optical media, random access memory (RAM), read-only memory (ROM), a data cache, a data object, etc. Storage unit 1240 may comprise any type of data storage for providing storage for information necessary to carry out the invention as described above. As such, storage unit 1240 may include one or more storage devices, such as a magnetic disk drive or an optical disk drive. Moreover, similar to CPU 1234, memory 1212 and/or storage unit 1240 may reside at a single physical location, comprising one or more types of data storage, or be distributed across a plurality of physical systems in various forms. Further, memory 1212 and/or storage unit 1240 can include data distributed across, for example, a LAN, a WAN or a storage area network (SAN) (not shown).

I/0 interface 1236 may comprise any system for exchanging information to/from one or more external I/O devices 1242. I/0 devices 1242 may comprise any known type of external device, including speakers, a CRT, LED screen, handheld device, keyboard, mouse, voice recognition system, speech output system, printer, monitor/display, facsimile, pager, communication hardware/software, etc. Bus 1246 provides a communication link between each of the components in computer 1210 and likewise may comprise any known type of transmission link, including electrical, optical, wireless, etc. Operating system software 1228, may also be present in the memory of the computer together with database software 1230.

It is understood that computers 1204 and 1208 typically include the same elements as shown in computer 1210 (e.g.,CPU, memory, I/O interface, etc.). These have not been separately shown and discussed for brevity. Further, it is understood that each computer 1204, 1208 and 1210 comprises any type of computing device capable of communicating with one or more other computing devices, such as a server, a desktop computer, a laptop, a handheld device, a mobile phone, a pager, a personal data tablet, etc. However, it is understood that if a computer 1204, 1408 or 1210 is a handheld device or the like, a display could be contained within the computer 1204, 1208 or 1210, and not as an external I/O device 1232 as shown for computer 1210.

Computer 1210 is shown including the previously described meeting application 1214 for managing a meeting. In particular, a user, such as user 1238, can operate meeting system 1214 to plan, conduct, store, and obtain data about a meeting. To this extent, meeting application 1214 is shown including a project module 1216 a contact module 1218 for obtaining a set of attendees for the meeting. To assist in conducting and retrieving information about the meeting, meeting application 1214 is shown including a minutes module 1222 for generating a minutes document using the meeting document, and a Project Item module 1224 to record the meeting outcomes. The processing and transfer of data between the meeting module and the Project Register is performed by the meeting application according to methods and rules as previously described.

While the system 1200 is shown implemented using a peer-to-peer network architecture (e.g., users 1202 and 1206 connect to computer 1210 operated by user 1240 in order to use meeting application 1214), it is understood that the system 1200 could be implemented using any type of network architecture. For example, the system 1200 could comprise a client-server network architecture in which meeting application 1214 executes on the server, and all users 1202, 1204 and 1240 connect to the server using their respective computers 1204, 1208 and 1210. In any event, it is understood that some of the various systems shown in FIG. 12 can be implemented independently, combined, duplicated, and/or stored in memory for one or more separate computers 1204, 1208 and 1210. For example, meeting application 1214 could be implemented on each computer 1204, 1208, and 1210, and the functions available to each user 1202, 1204 and 1240 can be varied based on the meeting document and the particular user 1202, 1204 or 1210. Further, it is understood that some of the systems and/or functionality may not be implemented, or additional systems and/or functionality may be included as part of system 1200.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

### CITATIONS

### Patent Literature

| | | |
|---|---|---|
| U.S. Pat. No. 7,146,381 B1 | December 2006 | Allen et al. Information Organization and |
| | | Collaboration Tool for Processing Notes and Action Requests |
| | | in Computer Systems. |
| US 2005/0131714 A1 | June 2005 | Braunstein et al. Method, System and Program |
| | | Product for Hierarchically Managing a Meeting. |
| U.S. Pat. No. 6,018,346 A | January 2000 | Moran et al. Freeform graphics system having |
| | | meeting objects for supporting meeting objectives |
| U.S. Pat. No. 7,047,192 | May 2006 | Poirier. Simultaneous multi-user real-time speech |
| | | recognition system. |
| U.S. Pat. No. 6,754,631 | June 2004 | Din. Recording meeting minutes based upon speech |
| | | recognition. |
| WO2006089355A1 | August 2006 | Doyle et al. A system for recording and analysing |
| | | meetings. |
| U.S. Pat. No. 6,100,882 | August 2000 | Adams et al. Textual recording of contributions to |
| | | audio conference using speech recognition. |

Electronic Meeting System Patents

| | | |
|---|---|---|
| U.S. Pat. No. 8,266,534 B2 | November 2012 | Curtis et al. Collaborative Generation of Meeting |
| | | Minutes and Agenda Confirmation. |
| US 2007/0112926 A1 | May 2007 | Brett et al. Meeting Management Method and |
| | | System. |
| U.S. Pat. No. 7,159,178 B2 | January 2007 | Vogt et al. System for supporting a Virtual |
| | | Community. |
| US 2003/0158845 A1 | August 2003 | Braley. Integrated Management Database |
| US 2006/0106872 A1 | May 2006 | Leban et al. Active Agenda |
| US 2006/0053194 A1 | March 2006 | Schneider et al. Systems and Methods for |
| | | Collaboration |
| US 2002/0032592 A1 | March 2002 | Krasnick et al. Online Meeting Planning Program |
| US 2007/0005408 A1 | January 2007 | Boss et al. Method and Structure for Agenda Based |
| | | Scheduling using Sub-Events with Automated |
| | | Management Functions |
| U.S. Pat. No. 10/648,991 | August 2003 | Karstens. System and Method for Dynamic Meeting |
| | | Agenda with Event Firing Progress Indicators |
| U.S. Pat. No. 7,530,021 B2 | May 2009 | Cheng et al. Instant Meeting Preparation |
| | | Architecture |
| U.S. Pat. No. 5,890,131 | March 1999 | Ebert et al. Project Organization and Optimization |
| | | Tool and Method of use Thereof |
| US 2007/0106931 A1 | May 2007 | Vartiainen et al. Active Notes Application |
| US 2009/0204414 A1 | August 2009 | Shah. Method and System to Enable In-Context |
| | | Pre-Meeting Dialogue and Collaboration Among Invitees |
| US 2007/0016661 A1 | January 2007 | Malik. Event Organizer |
| US 2009/0192845 A1 | July 2009 | Gudipaty et al. Integrated Real Time Collaboration |
| | | Experiences with Online Workspace. |

### Non-Patent Literature

Kolaco Inc TrackMeet www.trackmeet.net
Layer 2 GmbH Meeting Manager for Sharepoint 2010
Microsoft Sharepoint Server 2007 Help. Introduction to versioning
Softalot LLC Action Item Manager 7.0 Enterprise Edition User's Guide
Wikipedia “Electronic_meeting_system”

I claim:

1. A method, comprising:
providing a common platform to capture meeting and project content;
providing a user interface to capture a project item, and updates to a project item;
providing a user interface to capture meeting item content, inclusive of meeting minutes;
managing project item data, using a design that maintains a single version of a project item's properties, whilst handling associated updates, which:
add content to a project item, comprising either text or changes to the project item's properties, or a combination of both;
are sequenced within the project item using a time stamp that is derived either from the chronological order of their creation, or from an algorithm;
may contain either a single change to a project item property, or multiples changes to multiple properties, and following an algorithm, the said property change or changes, can be used to replace the relevant value or values, in the single version of the property item;
providing a user interface to record meeting minutes which can integrate user interfaces designed to capture project item content, allowing for both the capture of the meeting minutes and the identification of content for exportation to a project item;
managing meeting item data, using a design which can process the exportation of project item content from a meeting item to a project item.

2. The method of claim 1, further comprising:
an algorithm to assign to all new project item updates an update obtained time, a derived time stamp used to sequence the project item's updates, which specifies that:
if a project item update comes from a source other than a meeting, then the update obtained time shall be equivocal to its time of creation;
if a project item update comes from a meeting, then the update obtained time shall be, equivocal to the meeting end date and time that is exporting the new update to the project item.

3. The method of claim 1, further comprising:
an algorithm to assign to all new project item updates, an update obtained time that is a derived time stamp used to sequence the project item's updates, which specifies that:
if a project item update comes from a source other than a meeting, then the update obtained time shall be equivocal to its time of creation;
if a project item update comes from a meeting, then the update obtained time shall be calculated as follows:
if the exportation time is after the recorded meeting end date and time, then the update obtained time of the project item update, shall be equivalent to the meeting end date and time;
if the exportation time is before the recorded meeting end date and time, then the update obtained time of the project item update, is equivalent to the exportation date and time.

4. The method of claim 1, further comprising:
an algorithm to update a project item's properties, which specifies that:
if a project item receives a new update, and an assigned time stamp for sequencing the new update is equal to or later than the sequencing time stamp of the last update in the project item, then the new update shall be considered the most recent update;
if a new update is evaluated as being the most recent, and also contains changes to the project item's properties, then said changes shall replace the relevant project item's properties.

5. The method of claim 1, further comprising:
a design for handling the integration of multiple project item updates for a single project item, captured within a single meeting, said design requires that:
for each project item update within a meeting, an update is created within the project item;
said project item updates are assigned the same time stamp for sequencing, irrespective as to whether said time is derived from an algorithm or creation time, with the addition of an amount of time that proportionally represents the relative position of the update within the source meeting.

6. The method of claim 1, further comprising:
a design for handling revisions to meetings minutes that consequently introduce a discrepancy between the revised project items details recorded within the minutes, and previously exported project item details;
said design requires re-exporting the revised changes as new updates, which are then assigned the same time stamp as the update they are revising, but differ in having a more recent creation time;
said revision update is displayed to the user as over-writing the existing update.

7. The method of claim 1, further comprising:
a design for handling revisions to meetings minutes that consequently introduce a discrepancy between the revised project items details recorded within the minutes, and previously exported project item details;
said design requires re-exporting the revised changes as new updates, which are then assigned the same time stamp as the update they are revising, but differ in having a more recent creation time;
said revision update is displayed to the user as appended text to the revised project item's description property.

8. The method of claim 1, further comprising:
a design for handling revisions to meetings minutes that consequently introduce a discrepancy between the revised project items details recorded within the minutes, and previously exported project item details;
said design requires re-exporting revised changes to an update, as a new update, that is assigned the same time stamp as the update being revised;
said revision update is displayed to the user as a child of the update been revised; and where multiple meeting minute revisions, create multiple revised updates with the same time stamp for sequencing, creation time can be used as a secondary sort to display updates in sequence.

9. The method of claim 1, further comprising:
a design for handling revisions to meetings minutes that consequently introduce a discrepancy between the revised project items details recorded within the minutes, and previously exported project item details;
said design requires re-exporting revised changes to an update, as a new update, that is assigned the same time stamp as the update being revised;
said revision update is displayed to the user as new update in immediate succession to the revised update, sequenced using creation time as a secondary sort.

10. The method of claim 1, further comprising a design:
allowing captured project item meeting content, marked for exportation, to be saved without restriction, prior to the exportation of said project item meeting content to the project register;
upon a user's input, signalling that the project item meeting content should be exported to the project register, the system applies validation to all the content that is marked for exportation, and if there are any data inadequacies, the exportation is blocked; then
a user is given the option to correct the errors, or return to a pre-exportation state that then allows for the unverified saving of meeting project item content.

11. The method of claim 1, further comprising:
a design allowing meeting content to be created from various sources, where project items can be selected from the project item register, based on individual selections by a user, or by predetermined selection criteria, or a combination of both;
said selected items are passed to new meeting, and for each project item, a corresponding meeting project item update is generated within the minutes meeting interface.

12. A system, comprising one or more computing devices connected via a network, programmed to perform the method of claim 1.

13. A system, comprising one or more computing devices connected via a network, programmed to perform the method of claim 3.

14. A system, comprising one or more computing devices connected via a network, programmed to perform the method of claim 4.

15. A system, comprising one or more computing devices connected via a network, programmed to perform the method of claim 6.

16. A system, comprising one or more computing devices connected via a network, programmed to perform a method of claim 7.

17. A system, comprising one or more computing devices connected via a network, programmed to perform a method of claim 8.

18. A system, comprising one or more computing devices connected via a network, programmed to perform a method of claim 9.

19. A system, comprising one or more computing devices connected via a network, programmed to perform a method of claim 10.

20. A system, comprising one or more computing devices connected via a network, programmed to perform a method of claim 11.
